(19) United States
(12) Patent Application Publication
(10) Pub. No.: US 2026/0336809 A1
(43) Pub. Date: Oct. 29, 2026

(54) AIRCRAFT-SEAT DEVICE

(71) Applicant: RECARO Aircraft Seating GmbH & Co. KG, Schwaebisch Hall (DE)

(72) Inventors: Thomas DRENZECK, Michelfeld (DE); Michael HORLACHER, Schwäbisch Hall (DE); Maik THIELE, Stuttgart (DE)

(21) Appl. No.: 19/107,326

(22) PCT Filed: Sep. 1, 2023
(86) PCT No.: PCT/EP2023/074016

§ 371 Date: Feb. 27, 2025

(30) Foreign Application Priority Data
Sep. 2, 2022 (DE) 10 2022 122 321.3
Jun. 5, 2023 (DE) 10 2023 114 752.8

(51) Int. Cl. B64D 11/06

(52) U.S. Cl. CPC B64D 11/0696; B64D 11/064; B64D 11/0648

(57) ABSTRACT

An aircraft seat device comprises a mounting unit which is configured for mounting on a cabin floor and has at least one transverse beam, further comprises two seat-structure elements which are arranged in each case on one side of a seat region and have in each case one bearing point, further comprises a backrest which is attached via the bearing points of the seat-structure elements, and comprises a bearing device which is configured for supporting the backrest pivotably between an upright seat position and a comfort position, wherein the backrest comprises a pivotable backrest element, wherein the aircraft seat device has at least one restoring module which is configured at least for providing a restoring force for restoring the backrest from the comfort position into the upright sitting position and for this purpose is arranged at least substantially in a region above the bearing points of the seat-structure elements.

### CROSS-REFERENCE TO RELATED APPLICATIONS

This application is a U.S. national stage application of PCT/EP2023/074016 filed on Sep. 1, 2023 which is based on and claims the benefit of priority of the prior German Patent Application No. 10 2022 122 321.3 filed on Sep. 2, 2022 and German Patent Application No. 10 2023 114 752.8 filed on Jun. 5, 2023, the entire contents of which are incorporated herein by reference.

### PRIOR ART

The invention relates to an aircraft seat device.

An aircraft seat device having a mounting unit which is configured for mounting on a cabin floor and has at least one transverse beam, having two seat structure elements which are each arranged on one side of a seat region and each have a bearing point, having a backrest which is attached via the bearing points of the seat structure elements, and having a bearing device which is configured for supporting the backrest pivotably between an upright sitting position and a comfort position, wherein the backrest comprises a pivotable backrest element, has already been proposed.

The objective of the invention is in particular to provide a generic device with improved properties with regard to compactness and advantageously great leg freedom for a passenger. The objective is achieved according to the invention.

### ADVANTAGES OF THE INVENTION

The invention is based on an aircraft seat device having a mounting unit which is configured for mounting on a cabin floor and has at least one transverse beam, having two seat structure elements which are each arranged on one side of a seat region and each have a bearing point, having a backrest which is attached via the bearing points of the seat structure elements, and having a bearing device which is configured for supporting the backrest pivotably between an upright sitting position and a comfort position, wherein the backrest comprises a pivotable backrest element.

It is proposed that the aircraft seat device has at least one restoring module which is configured at least for providing a restoring force for restoring the backrest from the comfort position into the upright sitting position and for this purpose is arranged at least substantially in a region above the bearing points of the seat structure elements. An “aircraft seat device” should preferably be understood to mean at least one part, for example a subassembly, of an aircraft seat, in particular of an aircraft passenger seat. In principle, it would also be conceivable for the aircraft seat device to form the aircraft seat substantially or completely.

An “aircraft seat” should be understood to mean a seat for a passenger which is configured for being mounted on a cabin floor of an aircraft. The aircraft seat is preferably formed as part of an aircraft seat row of a plurality of aircraft seats arranged next to one another. The aircraft seat preferably comprises at least one seat bottom which forms a seat region for a passenger, and a backrest which provides a backrest contact surface against which a passenger sitting on the aircraft seat can rest his/her back. Furthermore, the aircraft seat has a mounting unit via which the aircraft seat is mounted on a cabin floor and to which the further components, such as the seat bottom and the backrest, are attached. A “mounting unit” should preferably be understood to mean a basic structure of the aircraft seat which forms a load-bearing structure of the aircraft seat. The aircraft seat is attached via the mounting unit on a mounting plane, that is to say in particular to the cabin floor. The mounting unit preferably has at least two seat feet and at least one transverse element which is coupled to the seat feet. The transverse element forms a support tube. The mounting unit preferably has two transverse elements, a front transverse element and a rear transverse element. The mounting unit is preferably coupled to the cabin floor via a plurality of fittings, preferably to corresponding fastening rails in the cabin floor. The mounting unit forms a load-bearing frame of the aircraft seat, preferably of the aircraft seat row.

A “seat structure element” should preferably be understood to mean a part of a load-bearing structure of the aircraft seat, to which further components of the aircraft seat, such as for example a backrest, a backrest element or an armrest, can be fastened. A seat structure element is preferably configured as a seat divider. The seat structure element embodied as a seat divider is preferably rigidly connected to the at least one, preferably to the two transverse elements of the mounting unit. The seat structure element embodied as a seat divider preferably extends from the front transverse element substantially horizontally into a region behind the rear transverse element. In a region behind the rear transverse element, the seat structure element embodied as a seat divider extends away from the mounting plane in a substantially vertical direction, preferably into an armrest height. In principle, it is also conceivable for the seat structure elements to be formed in one piece with a part of a seat shell, for example with a lower backrest element. The seat structure elements formed in one piece could in this case be formed for example by side regions of a seat shell.

A “bearing point” should preferably be understood to mean an attachment point via which a component, such as for example a backrest element, can be fixedly attached. A component can preferably be attached both rigidly and movably via a bearing point. The bearing point is preferably configured to attach a further component, such as in particular a backrest element, movably, preferably pivotably, to the component forming the bearing point. A “bearing device” should be understood to mean a module by means of which the backrest, in particular the pivotable backrest element, is pivotably supported on a unit, such as in particular the mounting unit. The bearing device can preferably be formed by a bearing bolt. In principle, it is likewise conceivable for the bearing device to be formed by a hinge or another bearing mechanism by means of which the backrest, in particular the pivotable backrest element, is pivotably supported. The bearing device forms an axis of rotation about which the backrest, in particular the pivotable backrest element, is pivotable. The fact that the backrest is pivotable should be understood to mean that at least one pivotable backrest element of the backrest is pivotable relative to a mounting structure, that is to say the mounting unit. A “pivotable backrest element” should preferably be understood to mean a backrest element which forms at least one part, preferably a large part, of the backrest surface of the backrest. The pivotable backrest element is pivotably supported relative to the mounting unit, in particular to the bearing points of the seat structure elements, in order to form the comfort position and the upright sitting position. The pivotable backrest element has a load-bearing basic structure and forms the backrest surface in its inner region. The pivotable backrest element preferably has a backrest frame and a fabric connected to the backrest frame or a shell element which forms the backrest surface. In principle, it would also be conceivable for the pivotable backrest element to be formed by a sandwich component. In this case, it would be conceivable for the pivotable backrest element not to have a backrest frame.

An “upright sitting position” should be understood to mean a maximum upright sitting position of the aircraft seat which has to be assumed for safety reasons, in particular in a starting phase, in a landing phase and during turbulence. The upright sitting position is in this case embodied as a so-called TTL position (taxi, takeoff, landing). In this case, in the upright sitting position, the backrest, in particular the pivotable backrest element, and the seat base of the aircraft seat are substantially perpendicular to one another, preferably at an angle of between 95 degrees and 115 degrees. A “comfort position” should be understood to mean, in particular, a rearwardly inclined sitting position of the aircraft seat in which at least the backrest, in particular a pivotable backrest element, is inclined rearwardly counter to a sitting direction of the aircraft seat, as a result of which a passenger sitting on the aircraft seat is enabled to have a comfortable, rearwardly inclined sitting position. In principle, it is also conceivable that, in the comfort position, in addition to the pivotable backrest element, the seat base is also inclined in contrast to the upright sitting position of the aircraft seat. In the comfort position, the backrest, in particular a pivotable backrest element, and the seat bottom can in particular have a different, in particular advantageously greater, angle with respect to one another than in the upright sitting position (TTL position). In the comfort position, the backrest, in particular the pivotable backrest element, is pivoted rearwardly from a maximum upright sitting position by at least 3 degrees, preferably at least 5 degrees, particularly preferably by more than 8 degrees.

A “restoring module” should preferably be understood to mean a module which is configured to exert a restoring force for restoring the backrest, in particular a movably supported backrest element, in order to move the latter from a position, in particular a comfort position, into an upright sitting position. For this purpose, the restoring module preferably has an element which provides a force for adjusting the backrest, in particular the pivotable backrest element. The element for providing a restoring force is preferably embodied as a spring element.

The restoring module has a locking unit which is configured to lock or unlock the restoring module itself and/or the pivotable backrest element. The locking unit has a locked state and an unlocked state. In its locked state, the locking unit locks the restoring module and/or the pivotable backrest element and the restoring module cannot exert a restoring force on the pivotable backrest element. In its unlocked state, the restoring module is unlocked by the locking unit and can exert a restoring force on the backrest, in particular the pivotable backrest element, in order to adjust the backrest into its upright seat position. The locking unit preferably has at least one locking element which mechanically locks the restoring module itself and/or the pivotable backrest element. The locking element is preferably embodied as a form-fitting and/or force-fitting element. The locking element is adjustable between a locked position and an unlocked position. The locking element is preferably adjustable between its locked position and its unlocked position by means of a mechanical adjusting element, for example a Bowden cable. In principle, it is also conceivable for the locking element to be adjustable between its locked position and its unlocked position by means of an electric actuator, for example an electromagnetic actuator. For example, it would also be conceivable for the locking element to be embodied as a part of an electronic actuator, in particular an electromechanical actuator. It is thus conceivable for the restoring module and/or the pivotable backrest element to be lockable or unlockable electrically or electronically by means of the locking unit. A “region substantially above the bearing points” should preferably be understood to mean a region which is located at least partially, preferably to a large extent above the bearing points. In this case, however, the region can likewise extend at least partially to below the bearing points. At least the locking unit of the restoring module and a part of the element for providing the restoring force are preferably located above the bearing points of the backrest. Particularly preferably, at least one third, preferably at least half and particularly preferably at least two thirds of the element for generating the restoring force, that is to say the spring element, is likewise arranged above the bearing points of the seat structure elements. “Above the bearing points” should be understood to mean on a side opposite the mounting plane, that is to say the cabin floor. “Configured” should be understood to mean, in particular, specially designed and/or equipped. The fact that an object is configured for a specific function should be understood to mean, in particular, that the object performs and/or carries out this specific function in at least one use state and/or operating state.

The aircraft seat is configured as a seat with a purely mechanical adjustment. In particular, an adjustment of the backrest, in particular of the pivotable backrest element, takes place merely by an adjustment force applied by a passenger and/or the force of a spring element. The aircraft seat preferably has no electromechanical actuators, by means of which an electric adjustment of the aircraft seat, in particular an electric adjustment of the aircraft seat, in particular of a backrest and/or of a seat bottom, between an upright sitting position and a comfort position is possible. The aircraft seat is preferably not embodied as a business-class or first-class seat which has an electronic aircraft seat adjustment.

By means of an implementation according to the invention, a particularly compact aircraft seat device can advantageously be provided, in which a restoring module is particularly advantageously arranged. Particularly advantageously, by means of the implementation according to the invention, an aircraft seat can be provided which provides a particularly advantageous leg freedom for a passenger, in particular a passenger sitting behind the aircraft seat. By means of an implementation according to the invention, the backrest can be embodied particularly narrowly in a region below the bearing point. As a result, an aircraft seat, in particular in a knee region, can be embodied particularly narrowly and have a particularly advantageously great leg freedom.

Furthermore, it is proposed that the seat structure elements extend in their rear region upwards, away from the mounting unit, up to at least substantially an armrest height, wherein the seat structure elements each have at their rear, upper end the bearing point for supporting the pivotable backrest element. A “rear region of the seat structure elements” should be understood to mean a rear region, which is opposite a front end, as seen in relation to the sitting direction of the aircraft seat. An “armrest height” should preferably be understood to mean a height at which an armrest of the aircraft seat device, in particular of the aircraft seat, is arranged and provides an arm resting surface for a passenger. The armrest height is preferably 550 mm to 700 mm relative to a cabin floor. An armrest height should preferably be understood to mean the height at which the armrest is attached to the mounting unit of the aircraft seat. As a result, a particularly advantageously high pivot point for the backrest, in particular the pivotable backrest element, can be provided, as a result of which, in particular, a particularly advantageously great leg freedom for a passenger sitting behind can be provided.

Furthermore, it is proposed that the restoring module has at least one spring element which is configured for providing the restoring force. A “spring element” should preferably be understood to mean an element which provides a spring force at least in one direction. The spring element is preferably embodied as a compression spring. The spring element is configured to exert a compressive force in one direction. In principle, it is conceivable for the spring element to be embodied as a mechanical spring, for example a spiral spring. In principle, it is also conceivable for the spring element to be embodied as a gas compression spring. It is likewise conceivable for the spring element to be embodied as an element which differs from a gas compression spring or a spiral spring. It is preferably conceivable for the spring element to be embodied as a leaf spring element. The spring element preferably has an actuated state and an unactuated state. In the actuated state, the spring element is configured to provide its spring force as a restoring force. An actuated state is preferably embodied as an unlocked state of the locking unit. An unactuated state of the spring element is embodied as a locked state of the spring element. In the unactuated state, the spring element is configured not to provide any spring force as a restoring force. The unactuated state is preferably embodied as a locked state of the locking unit. As a result, the restoring module for generating a restoring force can be embodied particularly simply.

It is furthermore proposed that the backrest has a lower backrest element which forms a lower region of the backrest and is fastened to the seat structure elements. A “lower backrest element” should preferably be understood to mean an element which rigidly forms a lower part of the backrest which faces a seat bottom. The lower backrest element is preferably formed by a shell element. The lower backrest element is preferably formed by a shell element composed of a fiber-reinforced plastic. In principle, it would also be conceivable for the lower shell element to be formed from an aluminum shell or metal shell composed of another metal, in particular a light metal. The lower backrest element is preferably embodied as a separate element. The lower backrest element is preferably fastened rigidly, that is to say immovably, to the seat structure elements. In principle, it is likewise conceivable for the lower backrest element to be formed in one piece with a seat shell of the seat bottom. As a result, the backrest can be embodied particularly advantageously and lightly.

Furthermore, it is proposed that the lower backrest element extends from a height of the at least one transverse beam up to a height of 450 mm- 700 mm measured from a mounting plane. The height of the lower backrest element is measured here in a vertical axis standing orthogonally on the mounting plane. Preferably, the backrest element extends up to a height of 500 mm-650 mm. As a result, the backrest element can be embodied particularly advantageously.

Furthermore, it is proposed that the spring element is embodied as a leaf spring element and is configured for being attached to the lower backrest element or to the mounting unit.

Preferably, the spring element embodied as a leaf spring element is arranged in an upper region of the lower backrest element. The spring element embodied as a leaf spring element is preferably attached in an upper half, preferably in an upper third, of the lower backrest element. “Attached” should preferably be understood to mean fixedly connected or abutting. The spring element embodied as a leaf spring element is attached by a first end to the lower backrest element. The spring element embodied as a leaf spring element is preferably attached by a second end to the pivotable backrest element. The spring element embodied as a leaf spring element can preferably be connected directly or indirectly to the pivotable backrest element or to the lower backrest element. Preferably, the restoring module has a first fastening unit for attaching the spring element embodied as a leaf spring element to the pivotable backrest element. Preferably, the restoring module has a second fastening unit for attaching the leaf spring element to the lower backrest element. Preferably, the first fastening unit or the second fastening unit is optionally embodied as a floating bearing via which the leaf spring element can carry out a relative movement to the pivotable backrest element or to the lower backrest element at least in one direction. In principle, it is also conceivable for both fastening units to be embodied as a floating bearing. In principle, it would also be conceivable for the spring element embodied as a leaf spring element to be attached to the mounting unit, for example to a transverse element or a seat structure element. A “leaf spring element” should preferably be understood to mean an elongate spring element which is configured to provide, in a tensioned state, a spring force which is configured substantially orthogonally to a main direction of extent of the leaf spring element. As a result, the spring element of the restoring module can be embodied particularly simply and in a space-saving manner.

Furthermore, it is proposed that the backrest has in a region above the bearing points a transverse beam to which the spring element embodied as a leaf spring element is attached for transmitting a restoring force to the pivotable backrest element. The spring element embodied as a leaf spring element can either be rigidly connected to the transverse beam or embodied integrally therewith. In principle, it is also conceivable for the spring element embodied as a leaf spring element to be attached movably, for example in a sliding manner, to the transverse beam. Preferably, a connection between the spring element embodied as a leaf spring element and the transverse beam has at least one degree of freedom. As a result, an introduction of force of the restoring force into the backrest, in particular the pivotable backrest element, can take place particularly advantageously.

Furthermore, it is proposed that the lower backrest element has at its upper end an upper lip which extends into a region above the bearing points for bearing the backrest. A “lip” should preferably be understood to mean a region which extends away from a region, in particular from the upper edge of the backrest element, at least in a partial region. The lip preferably extends at least over a partial region of the upper edge of the backrest element. The lip is preferably arranged centrally on the upper edge of the backrest element. In principle, it would also be conceivable for the lip to extend over an entire width of the upper edge of the backrest element. The lip is preferably formed in one piece with a remainder of the lower backrest element. The lip is formed in one piece with the backrest element formed by a shell element. The lip has a higher flexibility than a remainder of the backrest element. The lip is preferably formed by fewer layers than a remainder of the backrest element formed as a shell element. As a result, a particularly advantageous transition between the lower backrest element and a covering or a shell element of the upper, pivotable backrest element can be provided.

In addition, it is proposed that the pivotable backrest element has a backrest frame and a fabric which is clamped onto the backrest frame, or a shell element which is connected to the backrest frame. A “backrest frame” should preferably be understood to mean a rigid frame which runs around at least in three directions and in the center of which a fabric is configured which forms a backrest surface. A “fabric” should be understood to mean a textile which is tensioned in a central region clamped by the backrest frame and, in a tensioned state, forms a backrest surface. The backrest frame with the covering forms the upper, pivotably supported backrest element. As a result, the backrest can be embodied particularly simply and lightly.

Furthermore, it is proposed that the restoring module has a spring element which is embodied as a gas pressure spring and is arranged in a region above the bearing points. As a result, a spring element which can be actuated particularly simply can be provided for the restoring module.

Furthermore, it is proposed that the restoring module has at least one lever gear which is configured for transmitting a restoring force to the pivotable backrest element. As a result, a force transmission for the restoring force can be embodied particularly advantageously and an advantageously small spring element can be used.

Furthermore, it is proposed that the restoring module has a torsion tube which transmits a restoring force from one side of the backrest to an opposite side. Preferably, the restoring force of the restoring module is transmitted directly to the torsion tube. The torsion tube is configured for being rotated for adjusting the backrest, in particular the pivotable backrest element. As a result, a restoring of the backrest can take place particularly advantageously uniformly.

Furthermore, it is proposed that the bearing points for supporting the pivotable backrest element define an axis of rotation which is arranged above a knee region of the backrest. A “knee region” should preferably be understood to mean a region of the backrest in which the knees of a passenger sitting behind the aircraft seat are arranged. The knee region is preferably embodied as a region which extends from a lower end of the backrest into a region of at least 650 mm, particularly preferably of 700 mm above the mounting plane. The knee region is preferably embodied as a region of the backrest between 400 mm and 700 mm, particularly preferably as a region of the backrest between 450 mm and 650 mm, measured from the mounting plane. As a result, a particularly advantageous knee region for a passenger sitting behind the aircraft seat can be provided.

Furthermore, it is proposed that the spring element embodied as a leaf spring element for providing a restoring force is formed in one piece with a lower backrest element. As a result, the spring element embodied as a leaf spring element can be embodied particularly simply. Moreover, it is proposed that the spring element for generating the restoring force is at least partially formed in one piece with the pivotable backrest element. “In one piece” should be understood to mean, in particular, at least cohesively connected, for example by a welding process, an adhesive bonding process, an injection-molding process and/or another process which appears expedient to the person skilled in the art, and/or advantageously formed in one piece, such as for example by production from a casting and/or by production in a single-component or multi-component injection-molding method and advantageously from a single blank. That the spring element embodied as a leaf spring element is at least partially formed in one piece with the pivotable backrest element should preferably be understood to mean that at least one partial region of the spring element embodied as a leaf spring element is formed by the pivotable backrest element. As a result, the backrest can be embodied particularly narrowly in the region of the lower backrest element.

The aircraft seat device according to the invention should not be restricted here to the application and embodiment described above. In particular, the aircraft seat device according to the invention can have a number of individual elements, components and units differing from a number mentioned herein in order to fulfill a functionality described herein.

### DRAWINGS

Further advantages result from the following description of the drawings. Eleven exemplary embodiments of the invention are illustrated in the drawings. The drawings, the description and the claims contain numerous features in combination. The person skilled in the art will expediently also consider the features individually and combine them to form expedient further combinations.

In the drawings:

FIG. 1 shows a schematic view of an aircraft seat row with an aircraft seat device in a first exemplary embodiment with a backrest with an upper backrest pivot point and a restoring module with a spring element designed as a leaf spring element,

FIG. 2 shows a schematic rear view of the aircraft seat row with the restoring module and the spring element designed as a leaf spring element,

FIG. 3 shows a schematic side view with two aircraft seat rows and a pivotable backrest element in an upright sitting position and a comfort position,

FIG. 4 shows a detailed view of an attachment of the spring element designed as a leaf spring element by means of a fastening unit,

FIG. 5 shows a schematic view of an aircraft seat row with an aircraft seat device in a second exemplary embodiment with a backrest with an upper backrest pivot point, which has a fabric, and a restoring module with a spring element designed as a leaf spring element,

FIG. 6 shows a schematic rear view of the aircraft seat with the covered backrest element, which has a fabric, and the restoring module with the spring element designed as a leaf spring element,

FIG. 7 shows a schematic illustration of a pivotable backrest element, which forms a spring element designed as a leaf spring element, in a third exemplary embodiment of the aircraft seat device,

FIG. 8 shows a schematic illustration of an aircraft seat device in a fourth exemplary embodiment with a restoring module with a spring element designed as a leaf spring element, which is formed by a lower backrest element,

FIG. 9 shows a schematic illustration of an aircraft seat device in a fifth exemplary embodiment, with a restoring module which has a spring element designed as a gas pressure spring and a lever gear,

FIG. 10 shows a schematic detail illustration of a pivotable backrest element with the spring element designed as a gas pressure spring and the lever gear,

FIG. 11 shows a schematic detail illustration of the restoring module with the spring element designed as a gas pressure spring and the lever gear,

FIG. 12 shows a schematic illustration of an aircraft seat device in a sixth exemplary embodiment, with a restoring module which has a spring element designed as a gas pressure spring and a lever gear with a torsion tube,

FIG. 13 shows a schematic detail illustration of a pivotable backrest element in an upright sitting position,

FIG. 14 shows a schematic detail illustration of a pivotable backrest element in a comfort position,

FIG. 15 shows a schematic illustration of an aircraft seat device in a seventh exemplary embodiment, with a pivotable backrest with a lower backrest pivot point, and with a restoring module which has a spring element designed as a leaf spring element, and

FIG. 16 shows a schematic illustration of an aircraft seat device in an eighth exemplary embodiment, with a seat shell element which forms a seat bottom and a lower backrest element and with a restoring module which has a spring element designed as a leaf spring element,

FIG. 17 shows a schematic view of an aircraft seat row with an aircraft seat device in a ninth exemplary embodiment with a backrest with an upper backrest pivot point and a restoring module,

FIG. 18 shows a schematic rear view of an aircraft seat in the ninth exemplary embodiment,

FIG. 19 shows a schematic side view of the aircraft seat in the ninth exemplary embodiment,

FIG. 20 shows a schematic view of an upper backrest element with a restoring module which has two spring elements designed as spiral springs,

FIG. 21 shows a schematic view of an upper backrest element of an aircraft seat device in a tenth exemplary embodiment, with a restoring module which has two spring elements designed as bar springs, and

FIG. 22 shows a highly schematized view of a lower backrest element of an aircraft seat device in an eleventh exemplary embodiment.

### DESCRIPTION OF THE EXEMPLARY EMBODIMENTS

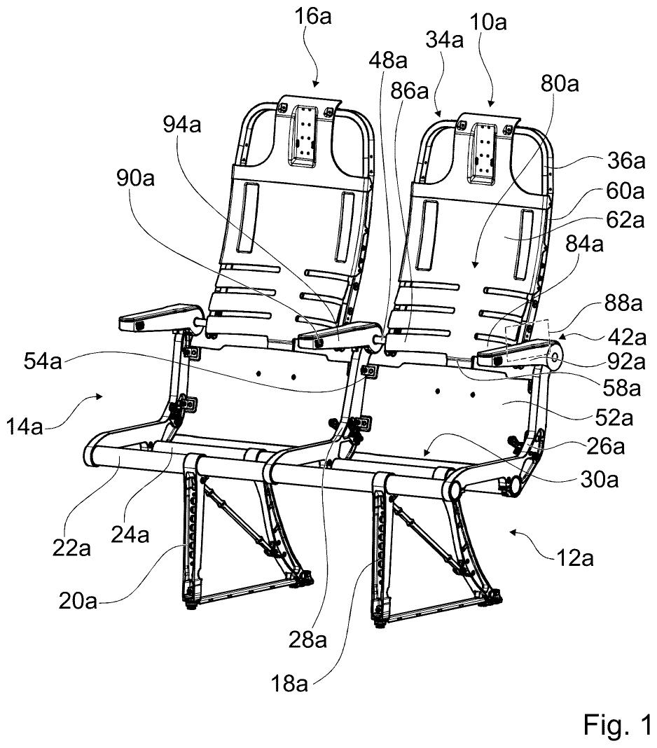

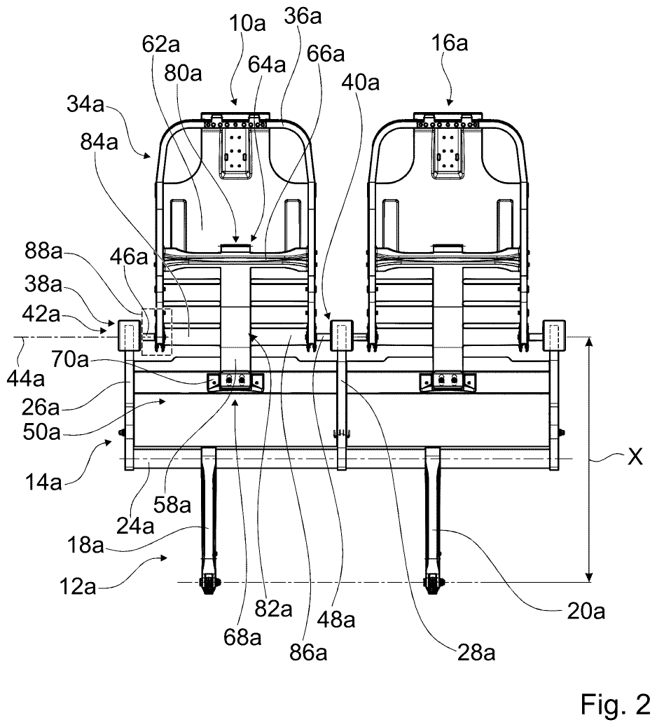

FIGS. 1 to 4 show an aircraft seat device in a first exemplary embodiment. In this case, the aircraft seat device is part of an aircraft seat 10a. In a mounted state, the aircraft seat 10a is mounted in an aircraft cabin of an aircraft. In a mounted state, the aircraft seat 10a is configured for being fixedly mounted on a cabin floor of the aircraft cabin. The aircraft seat device has a mounting unit 12a. The aircraft seat 10a can be mounted on the cabin floor of the aircraft cabin by means of the mounting unit 12a. The cabin floor forms a mounting plane. The aircraft seat 10a is formed as part of an aircraft seat row 14a. The aircraft seat 10a is preferably formed as part of an aircraft seat row 14a which comprises more than one aircraft seat 10a. By way of example, the aircraft seat row 14a with two aircraft seats 10a, 16a is shown in the figures. The aircraft seat row 14a shown by way of example has a second aircraft seat 16a. The further aircraft seat 16a is arranged adjacent to the first aircraft seat 10a. The second aircraft seat 16a is preferably formed identically to the first aircraft seat 10a, for which reason only the one aircraft seat 10a will be described in more detail below. In principle, it is also conceivable for the aircraft seat row 14a to have three or more aircraft seats 10a, 16a. In this case, the mounting unit 12a is formed as a common mounting unit 12a of the aircraft seats 10a, 16a of an aircraft seat row 14a. The mounting unit 12a comprises two seat feet 18a, 20a. The seat feet 18a, 20a are each coupled to fastening rails, which are fixedly connected to the cabin floor, via fittings which are not illustrated in more detail. The fittings can be locked fixedly in the fastening rails.

The mounting unit 12a has two transverse beams 22a, 24a. The transverse beams 22a, 24a are embodied as support tubes. A front transverse beam 22a is arranged in a front region of the aircraft seat 10a. A rear transverse beam 24a is arranged in a rear region of the aircraft seat 10a. The transverse beams 22a, 24a run in a transverse direction of the aircraft seat 10a. The transverse beams 22a, 24a extend at least substantially over an entire transverse extent of all the aircraft seats 10a of the aircraft seat row 14a. The aircraft seat device has two seat structure elements 26a, 28a. The two seat structure elements 26a, 28a are each arranged on one side of a seat region 30a of the aircraft seat device. The two seat structure elements 26a, 28a are each arranged laterally with respect to a seat region 30a which the aircraft seat 10a forms. The seat structure elements 26a, 28a are embodied as seat dividers. The seat structure elements 26a, 28a are arranged on the transverse beams 22a, 24a. The seat structure elements 26a, 28a are fastened to the transverse beams 22a, 24a at a distance from one another in the transverse direction. The seat structure elements 26a, 28a are connected in a positionally fixed manner to the transverse beams 22a, 24a. The seat structure elements 26a, 28a are each connected at their front end to the front transverse beam 22a. In this case, the seat structure elements 26a, 28a are preferably connected in a force-fitting and/or form-fitting manner to the front transverse beam 22a. The seat structure elements 26a, 28a are embodied in a substantially L-shaped manner. The seat structure elements 26a, 28a each have a first partial region which is oriented substantially horizontally in a mounted state. The seat structure elements 26a, 28a each have a second partial region which is oriented substantially vertically in the mounted state. The second partial region of the seat structure elements 26a, 28a is arranged in a rear region of the aircraft seat 10a. The second partial region of the seat structure elements 26a, 28a extends as far as a rear end of the seat structure elements 26a, 28a. The second partial region of the seat structure elements 26a, 28a forms a rear region of the seat structure elements 26a, 28a. The seat structure elements 26a, 28a thus extend upwards in their rear region, away from the mounting unit 12a, in particular the mounting plane. The seat structure elements 26a, 28a extend upwards in their rear region substantially as far as an armrest height X. The seat structure elements 26a, 28a extend as far as an armrest height X of the aircraft seat 10a.

The armrest height X is 650 mm. In principle, it is preferably conceivable for the armrest height X to be in a range between 500 mm-700 mm.

The seat structure elements 26a, 28a embodied as seat dividers are configured for the purpose of different components of the corresponding aircraft seat 10a, 16a being fastened thereto, as will be described at least partially in more detail below. In principle, it is also conceivable for the mounting unit 12a to have no or differently embodied seat structure elements 26a, 28a and for corresponding components of the aircraft seat 10a, 16a to be attached differently to the mounting unit 12a.

The aircraft seat device comprises a seat bottom 32a. The seat bottom 32a forms the seat region 30a. The seat bottom 32a forms a seat surface of the aircraft seat 10a. The seat bottom 32a has a main body and an upholstery element fixedly attached to the main body. The upholstery element forms the seat surface of the aircraft seat 10a. The seat bottom 32a is attached to the mounting unit 12a. The seat bottom 32a is in particular attached to the transverse beams 22a, 24a. The seat bottom 32a is coupled to the backrest 34a. The seat bottom 32a is coupled directly to the backrest 34a.

The aircraft seat device comprises a backrest 34a. In this case, the backrest 34a is configured such that a person sitting on the aircraft seat 10a, whose part is the aircraft seat device, can rest his/her back on the backrest 34a. The backrest 34a preferably has upholstery which is not illustrated in more detail. The backrest 34a forms a backrest contact surface. The backrest 34a is arranged at a rear end of the seat bottom 32a. The backrest 34a is arranged pivotably with respect to the mounting unit 12a. The backrest 34a is attached to the seat structure elements 26a, 28a. In this case, the aircraft seat 10a forms a sitting direction. The sitting direction is defined as the direction in which a passenger sits on the aircraft seat 10a. The sitting direction stands orthogonally on a backrest surface of the backrest 34a and runs parallel to the mounting plane in the direction of a front end of the seat bottom 32a.

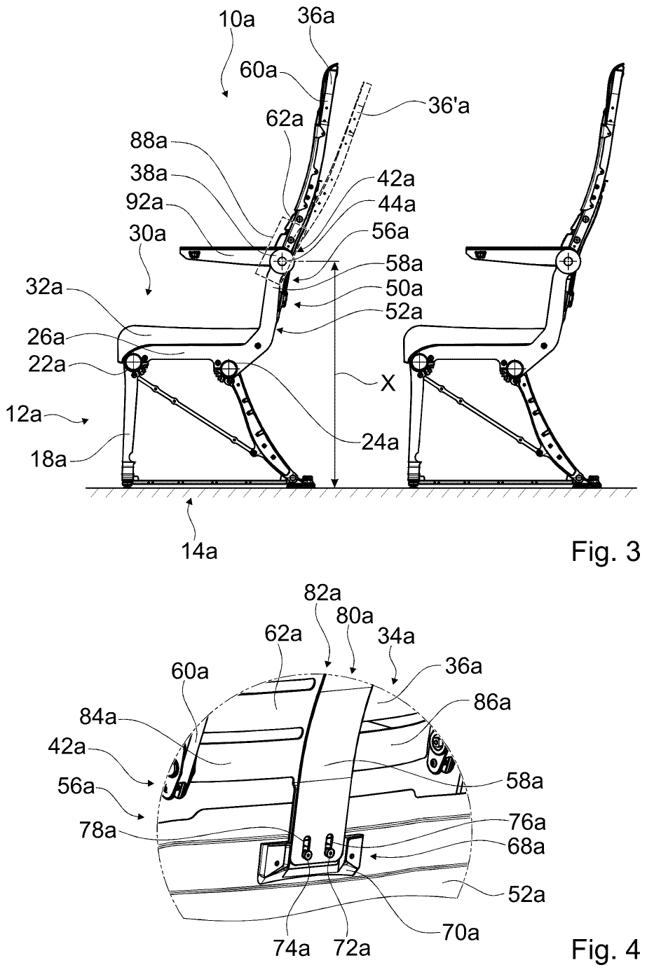

The backrest 34a is embodied pivotably. The backrest 34a is configured to be pivoted between an upright sitting position and a comfort position. The backrest 34a is configured to be pivoted relative to the mounting unit 12a. The backrest 34a is pivotable relative to the seat structure elements 26a, 28a. The backrest 34a has a pivotable backrest element 36a. The pivotable backrest element 36a is pivotably supported on the mounting unit 12a. The pivotable backrest element 36a is pivotably attached to the seat structure elements 26a, 28a. The seat structure elements 26a, 28a each have a bearing point 38a, 40a for supporting the backrest 34a. The bearing points 38a, 40a are configured such that the pivotable backrest element 36a is supported thereon. The pivotable backrest element 36a is pivotably attached to the seat structure elements 26a, 28a via the bearing points 38a, 40a. The bearing points 38a, 40a are embodied as bearing receptacles. The bearing points 38a, 40a define a position, in particular a height, of an axis of rotation 44a about which the backrest 34a, in particular the pivotable backrest element 36a, is pivotably supported. In FIG. 3, which illustrates a side view of the aircraft seat 10a, the backrest 34a is illustrated schematically in dashed form in the comfort position. The pivotable backrest element 36a is illustrated in dashed form in FIG. 3 as a pivotable backrest element 36a′ in the comfort position. The pivotable backrest element 36a′ is pivoted rearwardly from the upright sitting position by approximately 10 degrees counter to the sitting direction into its comfort position. In principle, it would also be conceivable that the pivotable backrest element 36a′ is pivoted rearwardly from the upright sitting position merely by 5 degrees or by 8 degrees in the comfort position.

The aircraft seat device has a bearing device 42a. The bearing device 42a is configured to support the backrest 34a pivotably between the upright sitting position and the comfort position. The bearing device 42a is configured to support the pivotable backrest element 36a pivotably between the upright sitting position and the comfort position. The bearing device 42a forms the axis of rotation 44a. The pivotable backrest element 36a is pivotable about the axis of rotation 44a by means of the bearing device 42a. The bearing device 42a has two bearing bolts 46a, 48a. The bearing bolts 46a, 48a form the axis of rotation 44a. The bearing bolts 46a, 48a are each connected to one of the bearing points 38a, 40a of one of the seat structure elements 26a, 28a. The bearing bolts 46a, 48a are preferably attached to the respective bearing point 38a, 40a in a rotationally fixed manner. The pivotable backrest element 36a is rotatably supported on the bearing bolts 46a, 48a. The pivotable backrest element 36a is preferably pivotably supported on the bearing bolts 46a, 48a via a slide bearing. In principle, it would also be conceivable for the pivotable backrest element 36a to be rotatably supported on the bearing bolts 46a, 48a by means of a roller bearing. In principle, it would also be conceivable for the bearing bolts 46a, 48a to be rotatably attached to the respective bearing points 38a, 40a of the seat structure elements 26a, 28a via a suitable bearing arrangement.

The pivotable backrest element 36a has a backrest frame 60a. The backrest frame 60a forms a load-bearing structure of the pivotable backrest element 36a. The backrest frame 60a is embodied as a circumferential frame. The backrest frame 60a is preferably embodied in a substantially U-shaped manner. The backrest frame 60a has two lateral frame elements and an upper frame element which connects the two lateral frame elements at an upper end of the backrest frame 60a. The backrest frame 60a is preferably open at a lower end. The lower end of the backrest frame 60a forms a lower end of the pivotable backrest element 36a. The bearing bolts 46a, 48a are each attached to the backrest frame 60a of the pivotable backrest element 36a at a lower end of the backrest frame 60a at the facing lateral frame element.

The pivotable backrest element 36a has a shell element 62a. The shell element 62a is embodied as a plate-like element. The shell element 62a is formed from a fiber-reinforced plastic. The shell element 62a is formed, for example, from a GRP or a CFRP. The shell element 62a is configured to form the backrest contact surface of the pivotable backrest element 36a. The shell element 62a is arranged in an inner region of the pivotable backrest element 36a which is clamped by the backrest frame 60a. The shell element 62a is fixedly connected to the backrest frame 60a of the pivotable backrest element 36a. The shell element 62a is fixedly connected at least in partial regions to the lateral frame elements of the backrest frame 60a. The shell element 62a is preferably attached at an upper end to the upper frame element of the backrest frame 60a. The shell element 62a preferably forms a backrest contour of the pivotable backrest element 36a. The shell element 62a is configured such that an upholstery element of the backrest 34a is attached thereto.

The pivotable backrest element 36a has a transverse beam 66a. The transverse beam 66a is arranged in a region above the bearing points 38a, 40a. As viewed in the vertical direction, the transverse beam 66a is arranged approximately in a center of the pivotable backrest element 36a. The transverse beam 66a is attached between the lateral frame elements of the backrest frame 60a. The transverse beam 66a extends between the lateral frame elements of the backrest frame 60a. The transverse beam 66a is in each case fixedly connected to the respective lateral frame element of the backrest frame 60a. The transverse beam 66a is preferably screwed to the lateral frame elements of the backrest frame 60a. In principle, it would also be conceivable for the transverse beam 66a to be adhesively bonded to the lateral frame elements of the backrest frame 60a, or to be connected in another manner in a form-fitting, force-fitting and/or cohesive manner. The transverse beam 66a is preferably configured for stiffening the backrest frame 60a, in particular for stiffening the entire pivotable backrest element 36a. Preferably, the transverse beam 66a can be configured such that further attachment elements of the backrest 34a are fastened thereto. For example, it would be conceivable for a pivotable table element, a cup holder, a tablet holder or a high literature bag to be attached to the transverse beam 66a to the backrest 34a, in particular the pivotable backrest element 36a.

The backrest 34a is designed as a backrest with a high backrest pivot point. The backrest pivot point is formed by the axis of rotation 44a of the bearing device 42a. The backrest pivot point, that is to say the axis of rotation 44a of the bearing device 42a, is arranged above a knee region 50a of the aircraft seat 10a. The knee region 50a of the aircraft seat 10a extends starting from the cabin floor up to a height of 650 mm. The knee region 50 a is arranged as a region in which a passenger sitting behind the aircraft seat 10a can arrange his knees.

In order to form the high backrest pivot point, the seat structure elements 26a, 28a form their bearing points 38a, 40a for supporting the backrest 34a in a high region. The seat structure elements 26a, 28a form their bearing points 38a, 40a in each case at an upper end. The seat structure elements 26a, 28a form their bearing points 38a, 40a at their upper end, facing away from the mounting plane, of the rear, second partial region. The bearing points 38a, 40a of the seat structure elements 26a, 28a are arranged above the knee region 50a.

The bearing points 38a, 40a of the seat structure elements 26a, 28a are arranged at the armrest height X. The bearing points 38a, 40a for supporting the pivotable backrest element 36a define the axis of rotation 44a which is arranged above the knee region 50a of the backrest 34a.

The pivotable backrest element 36a forms the backrest 34a above the bearing points 38a, 40a of the seat structure elements 26a, 28a. The pivotable backrest element 36a forms merely an upper region of the backrest 34a. The pivotable backrest element 36a is embodied as an upper backrest element. The pivotable backrest element 36a forms the backrest contact surface of the backrest 34a in a region above the armrest height X. The pivotable backrest element 36a is preferably arranged substantially merely in a region above the armrest height X. Merely regions for attaching the backrest element 36a to the seat structure elements 26a, 28a extend below the armrest height X.

The backrest 34a has a lower backrest element 52a. The lower backrest element 52a is embodied rigidly. The lower backrest element 52a is preferably embodied immovably. The lower backrest element 52a forms a lower region of the backrest 34a. The lower backrest element 52a forms the backrest contact surface in the lower region of the backrest 34a. The lower backrest element 52a is fastened fixedly to the seat structure elements 26a, 28a. The lower backrest element 52a extends substantially between a height of the transverse beams 22a, 24a of the mounting unit 12a and a lower end of the pivotable backrest element 36a.

The lower backrest element 52a extends preferably up to just below the armrest height X.

The lower backrest element 52a extends from a height of the transverse beams 22a, 24a up to a height of approximately 450 mm to 700 mm measured from the mounting plane. The lower backrest element 52 a extends preferably up to a height of 600 mm measured from the mounting plane.

The lower backrest element 52a is formed by a shell element. The lower backrest element 52a is formed by a shell composed of a fiber-reinforced plastic. For example, it is conceivable for the lower backrest element 52a to be formed by a GRP or a CFP shell. The lower backrest element 52a preferably has a slightly curved shape. The lower backrest element 52a is connected laterally via in each case two fastening elements 54a to one of the seat structure elements 26a, 28a. In principle, it would also be conceivable for the lower backrest element 52a to be formed at least partially in one piece with a seat bottom 32a, in particular a seat shell. In principle, it would likewise be conceivable for the lower backrest element 52a to be formed at least partially or completely by a covering.

The aircraft seat device has a restoring module 56a. The restoring module 56a is configured to restore the backrest 34a from the comfort position into an upright sitting position. The restoring module 56a is configured to restore the backrest 34a from its pivoted sitting position into the upright sitting position. The restoring module 56a is configured to restore the pivotable backrest element 36a. The restoring module 56a is configured to restore the backrest 34a, in particular to restore the pivotable backrest element 36a, in order to provide a restoring force. The restoring module 56a is configured to restore the backrest 34a in order to exert a restoring force on the pivotable backrest element 36a. The restoring module 56a is arranged at least substantially in a region above the bearing points 38a, 40a of the seat structure elements 26a, 28a. The restoring module 56a is arranged at least substantially above, that is to say on a side facing away from the mounting plane, the armrest height X.

The restoring module 56a is arranged at least to a large extent above the knee region 50a of the backrest 34a. As a result of this arrangement of the restoring module 56a, the knee region 50a of the backrest 34a can preferably remain substantially free of components of the restoring module 56a. In particular, relatively large components of the restoring module 56a can advantageously be arranged above the armrest height X and therefore outside the knee region 50a of the backrest 34a.

The restoring module 56a has a spring element 58a for providing a restoring force. In principle, it would also be conceivable for the restoring module 56a to have a plurality of spring elements 58a for providing the restoring force. The spring element 58a is configured to exert a spring force on the pivotable backrest element 36a in order to pivot the latter in the direction of its upright sitting position. The spring force of the spring element 58a forms the restoring force of the restoring module 56a. The spring element 58a is arranged functionally between the pivotable backrest element 36a and the mounting unit 12a. The spring element 58a is configured to be braced on the mounting unit 12a with a first side. The spring element 58a is configured to be braced on the backrest 34a, in particular on the pivotable backrest element 36a, with a second side. As a result, the spring element 58a can transmit a restoring force from the stationary mounting unit 12a to the pivotable backrest element 36a.

The spring element 58a is embodied as a leaf spring element. The spring element 58a embodied as a leaf spring element is embodied as an elongate component. The spring element 58a embodied as a leaf spring element is arranged functionally between the lower backrest element 52a and the pivotable backrest element 36a. The spring element 58a embodied as a leaf spring element is attached by its first, lower end to the lower backrest element 52a. The spring element 58a embodied as a leaf spring element is braced by its lower end on the lower backrest element 52a. The spring element 58a embodied as a leaf spring element is attached in an upper region of the lower backrest element 52a. The spring element 58a embodied as a leaf spring element thus extends partially into a region below the axis of rotation 44a, that is to say the armrest height X. The spring element 58a embodied as a leaf spring element is attached by a second, upper end to the pivotable backrest element 36a. The spring element 58a embodied as a leaf spring element is braced by its second, upper end on the pivotable backrest element 36a. The spring element 58a embodied as a leaf spring element preferably extends into a central region of the pivotable backrest element 52a.

For attaching the spring element 58a embodied as a leaf spring element to the pivotable backrest element 36a, the restoring module 56a has a first fastening unit 64a. The spring element 58a embodied as a leaf spring element is fixedly attached to the pivotable backrest element 36a via the first fastening unit 64a. The spring element 58a embodied as a leaf spring element is connected rigidly and immovably to the pivotable backrest element 36a via the first fastening unit 64a. In principle, it would also be conceivable for the spring element 58a embodied as a leaf spring element to be connected movably to the pivotable backrest element 36a via the first fastening unit 64a at least in one degree of freedom. Furthermore, it would likewise be conceivable for the spring element 58a embodied as a leaf spring element to abut merely against the pivotable backrest element 36a by its upper end. In this case, it would be conceivable for the spring element 58a embodied as a leaf spring element to slide by its upper end on the pivotable backrest element 36a, in particular on a rear side of the shell element 62a. The spring element 58a embodied as a leaf spring element is attached to the transverse beam 66a for transmitting the restoring force. The spring element 58a embodied as a leaf spring element is attached directly to the transverse beam 66a via the fastening unit 64a. By means of the transverse beam 66a, the restoring force provided by the spring element 58a embodied as a leaf spring element can be transmitted uniformly to both sides of the pivotable backrest element 36a.

For attaching the spring element 58a embodied as a leaf spring element to the lower backrest element 52a, the restoring module 56a has a second fastening unit 68a. The spring element 58a embodied as a leaf spring element is captively attached to the lower backrest element 52a via the second fastening unit 68a. The spring element 58a embodied as a leaf spring element is movably attached to the lower backrest element 52a via the second fastening unit 68a. The second fastening unit 68a has a fastening main body 70a. The fastening main body 70a is fixedly attached to a rear side of the lower backrest element 52a. The fastening main body 70a of the second fastening unit 68a has a receptacle which is configured for receiving the spring element 58a embodied as a leaf spring element. The spring element 58a embodied as a leaf spring element is displaceably supported in the receptacle of the fastening main body 70a. The receptacle of the fastening main body 70a forms a displacement axis along which the spring element 58a embodied as a leaf spring element is displaceably supported. The displacement axis is oriented vertically in a mounted state. The fastening unit 68a has two fastening elements 72a, 74a which attach the spring element 58a embodied as a leaf spring element to the fastening main body 70a. The fastening elements 72a, 74a are embodied as fastening screws. In principle, it would also be conceivable for the fastening elements 72a, 74a to be embodied in a different manner. For attachment to the fastening main body 70a, the spring element 58a embodied as a leaf spring element has two through-grooves 76a, 78a. For attachment of the spring element 58a embodied as a leaf spring element, the fastening elements 72a, 74a are guided through the through-grooves 76a, 78a.

The spring element 58a embodied as a leaf spring element is at least partially integrated into the pivotable backrest element 36a. The spring element 58a embodied as a leaf spring element is partially integrated into the shell element 62a of the pivotable backrest element 36a. The spring element 58a embodied as a leaf spring element is configured to be received in the shell element 62a of the pivotable backrest element 36a. The shell element 62a of the pivotable backrest element 36a has a central region 80a. The central region 80a is arranged centrally between the lateral frame elements of the backrest frame 60a in relation to a transverse direction. The spring element 58a embodied as a leaf spring element is at least partially integrated into the central region 80a of the shell element 62a. The shell element 62a has, on its rear side in the central region 80a, a receiving region 82a for the spring element 58a embodied as a leaf spring element. The receiving region 82a extends in the central region 80a from a lower end of the shell element 62a into a region below the transverse beam 66a. In principle, it is likewise conceivable for the spring element 58a embodied as a leaf spring element to rest merely on the rear side of the shell element 62a in the central region 80a. It would likewise be conceivable for the spring element 58a embodied as a leaf spring element not to make contact with the shell element 62a in the central region 80a.

The pivotable backrest element 36a has, in a lower region, elastic ribs 84a, 86a which each extend laterally outward from the central region 80a. By way of example, three elastic ribs 84a, 86a are in each case illustrated per side in the exemplary embodiment. The elastic ribs 84a, 86a each extend from the central region 80a as far as the lateral frame elements of the backrest frame 60a. The ribs 84a, 86a arranged adjacently on one side of the central region 80a are each at a distance from one another in the vertical direction. The elastic ribs 84a, 86a are each elastically deformable independently of one another. The elastic ribs 84a, 86a each have a shape which is curved forward in the sitting direction. The elastic ribs 84a, 86a are preferably formed in one piece with the shell element 62a, in particular with the central region 80a. In principle, it would likewise be conceivable for the elastic ribs 84a, 86a to be formed at least partially separately from the shell element 62a. In this case, it would be conceivable in particular for the ribs 84a, 86a to be formed partially as separate elements which are connected to the shell element 62a, in particular the central region 80a of the shell element 62a. In this case, it is conceivable in particular for the separately formed ribs 84a, 86a to be attachable to the shell element 62a in a demountable manner. As a result, the ribs 84a, 86a could be replaced advantageously simply if they are damaged. Preferably, ribs 84a, 86a with different rigidities can be attached particularly simply by means of the demountably formed ribs 84a, 86a at different points of the pivotable backrest element 36a. As a result, the pivotable backrest element 36a can be embodied particularly simply and differently rigidly in different partial regions. Preferably, ribs 84a, 86a which are formed differently simply can be arranged by means of the demountably formed ribs 84a, 86a at different points of the pivotable backrest element 36a. As a result, the pivotable backrest element 36a can be embodied particularly simply with different or adaptable ergonomies.

The restoring module 56a has a locking unit 88a. The locking unit 88a is configured to lock or unlock the restoring module 56a. The locking unit 88a is configured to lock the backrest 34a, that is to say the pivotable backrest element 36a, at least in the upright sitting position and in the comfort position. Preferably, it is likewise conceivable for the locking unit 88a to be configured to lock the pivotable backrest element 36a in further positions. The further positions of the pivotable backrest element 36a are in this case embodied in particular as pivoted positions which lie between the upright sitting position and the comfort position. The locking unit 88a has a locked state and an unlocked state. In its locked state, the locking unit 88a locks the restoring module 56a and the restoring module 56a cannot exert a restoring force on the pivotable backrest element 36a. In its unlocked state, the locking unit 88a unlocks the restoring module 56a and the restoring module 56a can exert the restoring force on the pivotable backrest element 36a. The locking unit 88a is configured to lock the pivotable backrest element 36a in its current position in its locked state. In the locked state of the locking unit 88a, the pivotable backrest element 36a is locked in its current position. In the locked state of the locking unit 88a, the pivotable backrest element 36a is not pivotable. In the locked state of the locking unit 88a, the pivotable backrest element 36a is preferably fixed relative to the mounting unit 12a. Preferably, the pivotable backrest element 36a is fixedly fixed relative to the seat structure elements 26a, 28a in the locked state of the locking unit 88a.

The locking unit 88a is preferably arranged functionally between the pivotable backrest element 36a, in particular the backrest frame 60a, and one of the seat structure elements 26a, 28a. In principle, it is likewise conceivable for the locking unit 88a to be arranged functionally between the backrest frame 60a and the two seat structure elements 26a, 28a. The locking unit 88a preferably has at least one locking element. The locking element of the locking unit 88a is preferably configured to lock the restoring module 56a in the locked state of the locking unit 88a. The locking element of the locking unit 88a is preferably configured to lock the pivotable backrest element 36a directly. The locking element of the locking unit 88a is configured for form-fitting locking of the pivotable backrest element 36a. The locking element of the locking unit 88a is configured to engage in a form-fitting manner in a corresponding form-fitting element of the locking unit 88a in the locked state of the locking unit 88a. The locking unit 88a has a corresponding form-fitting element for each lockable position, that is to say for the upright sitting position and for the comfort position of the pivotable backrest element 36a. In principle, it would also be conceivable for the locking unit 88a to be configured to lock the pivotable backrest element 36a in a force-fitting manner and to have at least one force-fitting element for this purpose. In principle, it would likewise be conceivable for the locking unit 88a to be configured for force-fitting and form-fitting locking of the pivotable backrest element 36a. The locking unit 88a has an actuating element 90a, by means of which the locking unit 88a can be adjusted from the locked state into the unlocked state. The actuating element 90a is configured to be actuated by a passenger sitting on the aircraft seat 10a. The actuating element 90a is preferably embodied as a pushbutton. The actuating element 90a is coupled to the locking element of the locking unit 88a via a suitable connecting element, in particular a Bowden cable, in order to adjust said locking element between its locked position and unlocked position.

The locking unit 88a is arranged above the knee region 50a of the backrest 34a. The locking unit 88a is preferably arranged in a region above the bearing points 38a, 40a of the seat structure elements 26a, 28a. The locking unit 88a is preferably arranged substantially, that is to say to a large extent, above the armrest height X. The locking unit 88a is arranged in a region of the pivotable backrest element 36a. The locking unit 88a is preferably arranged outside a region of the lower backrest element 52a. In particular, the locking element and the correspondingly embodied form-fitting elements of the locking unit 88a for locking the pivotable backrest element 36a are arranged above the bearing points 38a, 40a and the armrest height X. Individual constituent parts of the locking unit 88a, in particular the actuating element 90a, and a Bowden cable can also be arranged partially below the armrest height X.

The aircraft seat device has two armrests 92a, 94a. The armrests 92a, 94a are part of the aircraft seat 10a of the aircraft seat row 14a. The armrests 92a, 94a are each arranged laterally with respect to the seat region 30a of the aircraft seat 10a. The armrests 92a, 94a are attached at the armrest height X. The armrests 92a, 94a are attached to the mounting unit 12a with a rear end at the armrest height X. The armrests 92a, 94a are attached via the seat structure elements 26a, 28a. The armrests 92a, 94a are attached to the aircraft seat 10a via the bearing points 38a, 40a of the seat structure elements 26a, 28a embodied as seat dividers. The armrests 92a, 94a are attached to the seat structure elements 26a, 28a via the bearing bolts 46a, 48a of the bearing device 42a of the backrest 34a. The armrests 92a, 94a are attached to the seat structure elements 26a, 28a via the same bearing bolts 46a, 48a as the pivotable backrest element 36a. The armrests 92a, 94a are preferably attached pivotably to the seat structure elements 26a, 28a. The armrests 92a, 94a are pivotable about the same axis of rotation 44a as the pivotable backrest element 36a. In principle, it would also be conceivable for the armrests 92a, 94a to be attached to the seat structure elements 26a, 28a in a rotationally fixed manner. The actuating element 90a of the locking unit 88a is preferably introduced into one of the armrests 92a, 94a.

Alternatively, it would also be conceivable for the spring element 58a embodied as a leaf spring element to be attached directly to the mounting unit 12a. In this case, it would be conceivable for the spring element 58a embodied as a leaf spring element to be attached directly to the rear transverse beam 24a of the mounting unit 12a instead of to the lower backrest element 52a. In this case, it would be conceivable for the spring element 58a embodied as a leaf spring element to be arranged in a lateral region, directly in the region of one of the laterally arranged seat structure elements 26a, 28a. As a result, a central region of the knee region 50a of the backrest 34a could advantageously be embodied free of the spring element 58a.

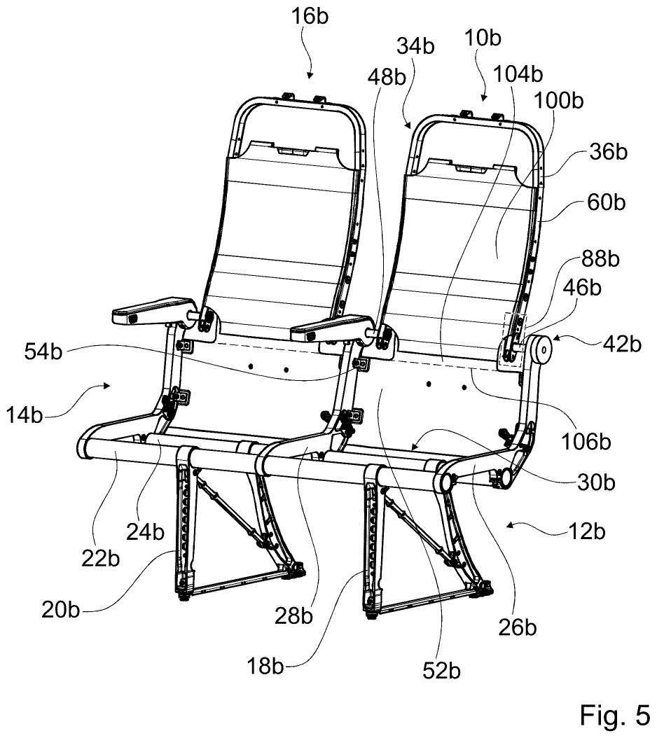

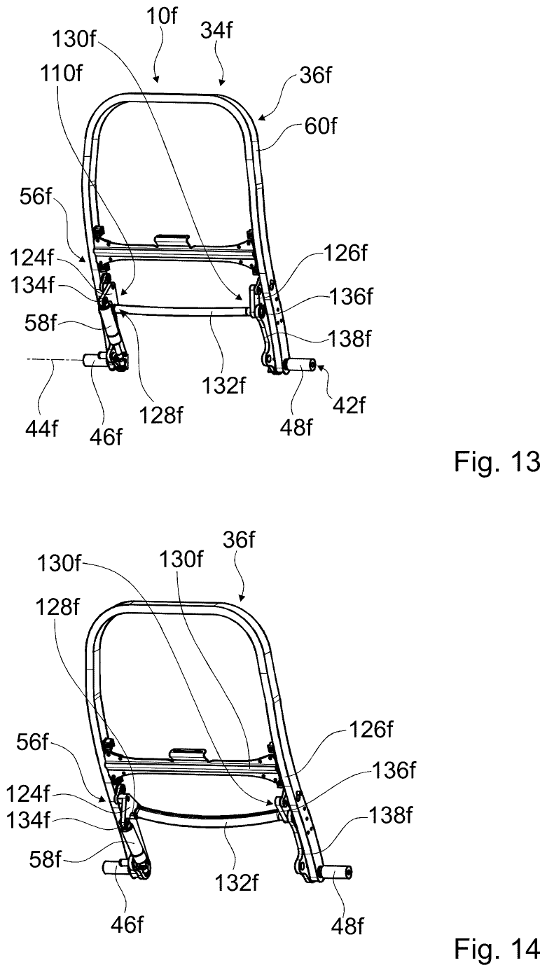

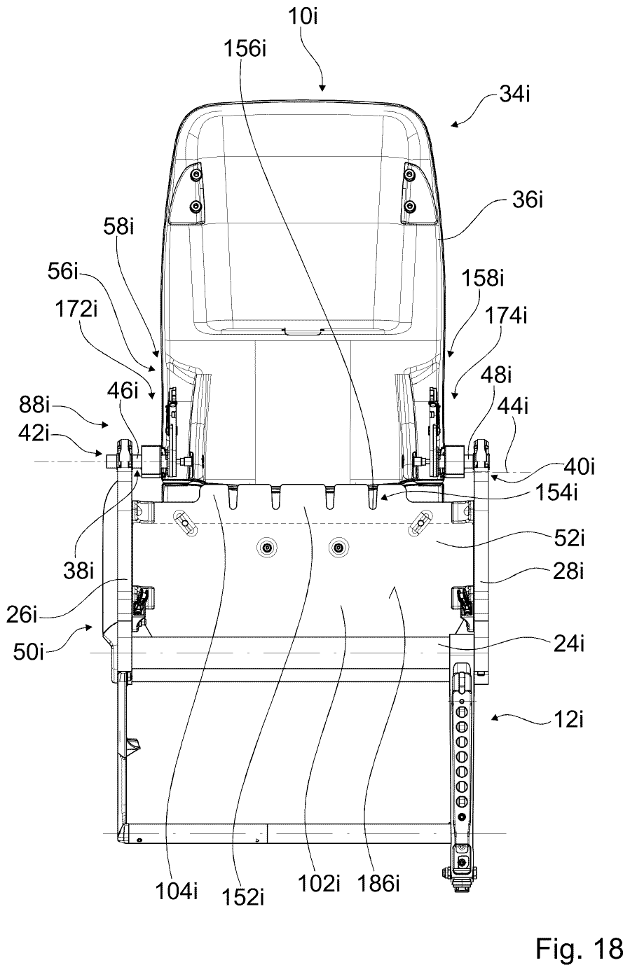

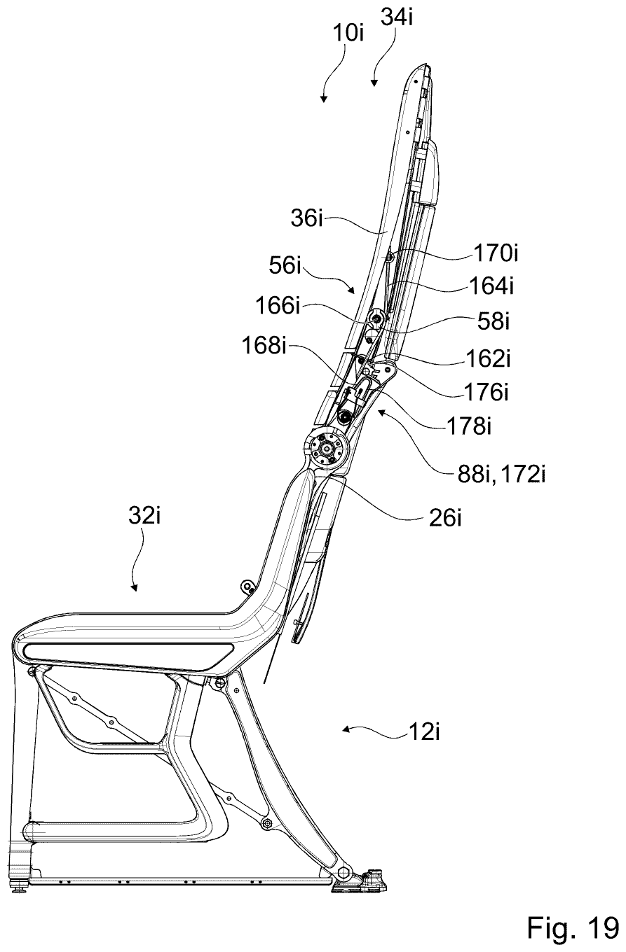

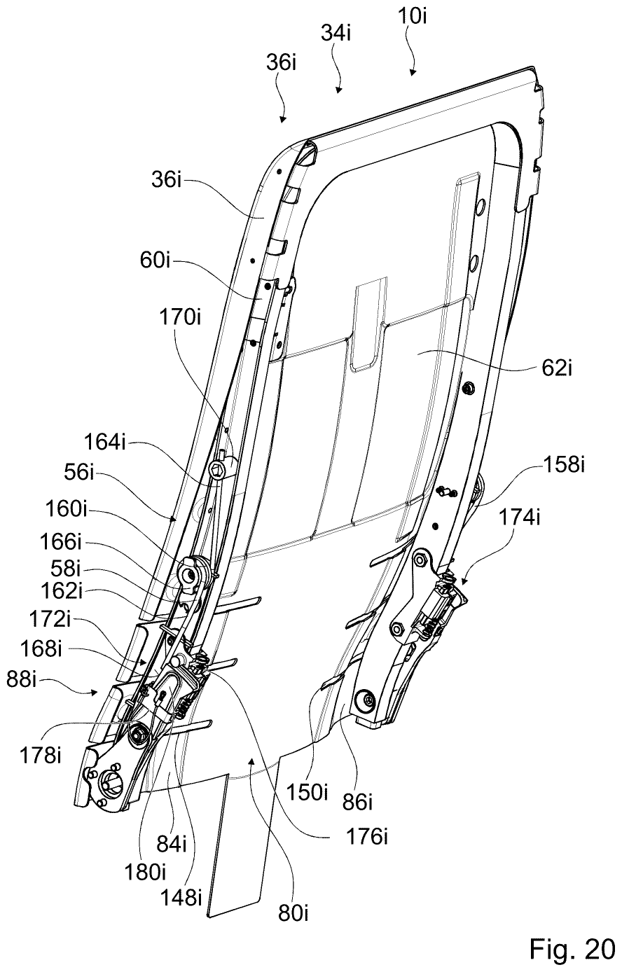

Ten further exemplary embodiments of the invention are shown in FIGS. 5 to 22. The following descriptions and the drawings are restricted substantially to the differences between the exemplary embodiments, wherein, in relation to components with the same designation, in particular in relation to components with the same reference signs, reference can basically also be made to the drawings and/or the description of the other exemplary embodiments, in particular of FIGS. 1 to 4. In order to differentiate between the exemplary embodiments, the letter a is added after the reference signs of the exemplary embodiment in FIGS. 1 to 4. In the exemplary embodiments of FIGS. 5 to 22, the letter a is replaced by the letters b to k.

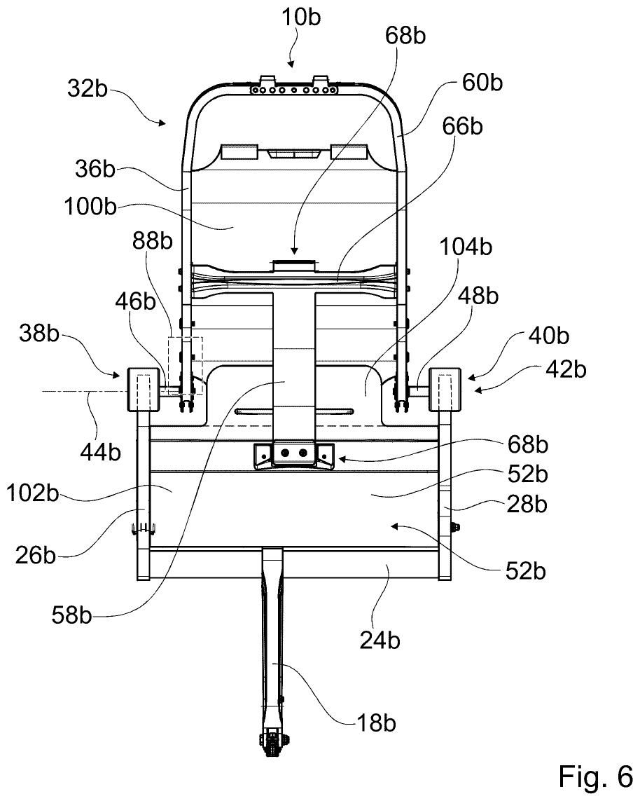

FIGS. 5 and 6 show a second exemplary embodiment of an aircraft seat device according to the invention. In this case, the aircraft seat device is part of an aircraft seat 10b. In a mounted state, the aircraft seat 10b is mounted in an aircraft cabin of an aircraft. The aircraft seat device has a mounting unit 12b. The aircraft seat 10b can be mounted on the cabin floor of the aircraft cabin by means of the mounting unit 12b. The aircraft seat 10b is formed as part of an aircraft seat row 14b. The aircraft seat row 14b shown by way of example has a second aircraft seat 16b. In this case, the mounting unit 12b is formed as a common mounting unit of the aircraft seats 10b, 16b of an aircraft seat row 14b. The mounting unit 12b comprises two seat feet 18b, 20b. The mounting unit 12b has two transverse beams 22b, 24b.

The aircraft seat device has two seat structure elements 26b, 28b. The two seat structure elements 26b, 28b are each arranged on one side of a seat region 30b of the aircraft seat device. The two seat structure elements 26b, 28b are each arranged laterally with respect to a seat region 30b which the aircraft seat 10b forms. The seat structure elements 26b, 28b are embodied as seat dividers. The seat structure elements 26b, 28b are arranged on the transverse beams 22b, 24b. The seat structure elements 26b, 28b are embodied in a substantially L-shaped manner. The seat structure elements 26b, 28b thus extend upwards in their rear region, away from the mounting unit 12b, in particular the mounting plane. The seat structure elements 26b, 28b extend upwards in their rear region substantially as far as an armrest height X. The seat structure elements 26b, 28b extend as far as an armrest height X of the aircraft seat 10b.

The aircraft seat device comprises a backrest 34b. The backrest 34b is configured such that a person sitting on the aircraft seat 10b, whose part is the aircraft seat device, can rest his/her back on the backrest 34b. The backrest 34b is arranged pivotably with respect to the mounting unit 12b. The backrest 34b is attached to the seat structure elements 26b, 28b. The backrest 34b is configured to be pivoted between an upright sitting position and a comfort position. The backrest 34b has a pivotable backrest element 36b. The pivotable backrest element 36b is pivotably supported on the mounting unit 12b. The pivotable backrest element 36b is pivotably attached to the seat structure elements 26b, 28b. The seat structure elements 26b, 28b each have a bearing point 38b, 40b for supporting the backrest 34b. The bearing points 38b, 40b are configured such that the pivotable backrest element 36b is supported thereon.

The aircraft seat device has a bearing device 42b. The bearing device 42b is configured to support the backrest 34b pivotably between the upright sitting position and the comfort position. The bearing device 42b is configured to support the pivotable backrest element 36b pivotably between the upright sitting position and the comfort position. The bearing device 42b forms the axis of rotation 44b. The pivotable backrest element 36b is pivotable about the axis of rotation 44b by means of the bearing device 42b. The bearing device 42b has two bearing bolts 46b, 48b. The bearing bolts 46b, 48b form the axis of rotation 44b. The bearing bolts 46b, 48b are each connected to one of the bearing points 38b, 40b of one of the seat structure elements 26b, 28b.

The pivotable backrest element 36b has a backrest frame 60b. The backrest frame 60b forms a load-bearing structure of the pivotable backrest element 36b. The backrest frame 60b is embodied as a circumferential frame. The backrest frame 60b is preferably embodied in a substantially U-shaped manner. The backrest frame 60b has two lateral frame elements and an upper frame element which connects the two lateral frame elements at an upper end of the backrest frame 60b. The backrest frame 60b is preferably open at a lower end. The lower end of the backrest frame 60b forms a lower end of the pivotable backrest element 36b. The bearing bolts 46b, 48b are each attached to the backrest frame 60b of the pivotable backrest element 36b at a lower end of the backrest frame 60b at the facing lateral frame element.

The backrest 34b is designed as a backrest with a high backrest pivot point. The backrest pivot point, that is to say the axis of rotation 44b of the bearing device 42b, is arranged above a knee region 50b of the aircraft seat 10b. In order to form the high backrest pivot point, the seat structure elements 26b, 28b form their bearing points 38b, 40b for supporting the backrest 34b in a high region. The bearing points 38b, 40b of the seat structure elements 26b, 28b are arranged above the knee region 50b. The bearing points 38b, 40b of the seat structure elements 26b, 28b are arranged at the armrest height X.

In contrast to the first exemplary embodiment, the pivotable backrest element 36b has a fabric 100b. The fabric 100b is clamped onto the backrest frame 60b. The fabric 100b is formed by a textile which is clamped between the lateral frame elements of the backrest frame 60b. In principle, it is conceivable for the fabric 100b also to be attached to an upper frame element of the backrest frame 60b. The fabric 100b extends from a lower end of the backrest frame 60b into an upper end region of the backrest frame 60b.

The backrest 34b has a lower backrest element 52b. The lower backrest element 52b is embodied rigidly. The lower backrest element 52b is preferably embodied immovably. The lower backrest element 52b forms a lower region of the backrest 34b. The lower backrest element 52b forms the backrest contact surface in the lower region of the backrest 34b. The lower backrest element 52b is fastened fixedly to the seat structure elements 26b, 28b. The lower backrest element 52b is formed by a shell element. The lower backrest element 52b is embodied from a fiber-reinforced plastic. The lower backrest element 52b is preferably formed from a plurality of layers of a fiber-reinforced plastic. For example, it is conceivable for the lower backrest element 52b to be formed by one or more GRP layers or by one or more CFP layers. The lower backrest element 52b has a main region 102b. The main region 102b substantially forms the backrest contact surface of the lower backrest element 52b and is embodied substantially as in the case of the lower backrest element of the first exemplary embodiment.

In contrast to the first exemplary embodiment, the lower backrest element 52b has a lip 104b at its upper end. The lip 104b directly adjoins an upper end of the main region 102b of the lower backrest element 52b. The lip 104b forms an upper end region of the lower backrest element 52b. The lip 104b is formed in one piece with the remainder of the lower backrest element 52b. The lip 104b is arranged centrally on the upper end of the lower backrest element 52b in the transverse direction. In principle, it would also be conceivable for the lower backrest element 52b also to have two or more eccentrically arranged lips 104b which are arranged at its upper end. If the lower backrest element 52b has a plurality of lips 104b at its upper end, said lips are preferably arranged symmetrically with respect to a central axis of the lower backrest element 52b. The lip 104b of the lower backrest element 52b extends into a region above the bearing points 38b, 40b for supporting the pivotable backrest element 36b. The lip 104b of the lower backrest element 52b extends into a region behind the pivotable backrest element 36b, in particular into a region behind the fabric 100b of the pivotable backrest element 36b. The lip 104b is configured for the purpose that the fabric 100b of the pivotable backrest element 36b can be attached thereto by way of its lower end. The fabric 100b is attached by way of its lower end to a front side 106b of the lip 104b of the lower backrest element 52b. The fabric 100b is preferably detachably attached to the front side 106b of the lip 104b by means of a loop and hook strap. In principle, it is also conceivable for the fabric 100b to be connected, for example adhesively bonded, to the lip 104b of the lower backrest element 52b in a different manner.

The aircraft seat device has a restoring module 56b. The restoring module 56b is configured to restore the backrest 34b from the comfort position into an upright sitting position. The restoring module 56b is configured to restore the backrest 34b from the pivoted sitting position into the upright sitting position. The restoring module 56b is arranged at least substantially in a region above the bearing points 38b, 40b of the seat structure elements 26b, 28b. The restoring module 56b is arranged at least substantially above, that is to say on a side facing away from the mounting plane, the armrest height X. The restoring module 56b is arranged at least to a large extent above the knee region 50b of the backrest 34b.

The restoring module 56b has a spring element 58b for providing a restoring force. The spring element 58b is configured to exert a spring force on the pivotable backrest element 36b in order to pivot the latter in the direction of the upright sitting position. The spring element 58b is embodied as a leaf spring element. The spring element 58b embodied as a leaf spring element is attached by its first, lower end to the lower backrest element 52b. The spring element 58b embodied as a leaf spring element is attached in an upper region of the lower backrest element 52b. The spring element 58b embodied as a leaf spring element is attached below the lip 104b in the main region 102b of the lower backrest element 52b.

For attaching the spring element 58b embodied as a leaf spring element to the pivotable backrest element 36b, the restoring module 56b has a first fastening unit 64b. The spring element 58b embodied as a leaf spring element is fixedly attached to the pivotable backrest element 36b via the first fastening unit 64b. The pivotable backrest element 36b has a transverse beam 66b. The transverse beam 66b is arranged in a region above the bearing points 38b, 40b. The transverse beam 66b is arranged behind the fabric 100b. The spring element 58b embodied as a leaf spring element is attached directly to the transverse beam 66b via the fastening unit 64b. For attaching the spring element 58b embodied as a leaf spring element to the lower backrest element 52b, the restoring module 56b has a second fastening unit 68b. The spring element 58b embodied as a leaf spring element is captively attached to the lower backrest element 52b via the second fastening unit 68b. The spring element 58b embodied as a leaf spring element is movably attached to the lower backrest element 52b via the second fastening unit 68b.

The restoring module 56b has a locking unit 88b. The locking unit 88b is configured to lock or unlock the restoring module 56b. The locking unit 88b is configured to lock the backrest 34b, that is to say the pivotable backrest element 36b, at least in the upright sitting position and in the comfort position. The locking unit 88b is preferably arranged functionally between the pivotable backrest element 36b, in particular the backrest frame 60b, and one of the seat structure elements 26b, 28b. The locking unit 88b is arranged above the knee region 50b of the backrest 34b. The locking unit 88b is preferably arranged in a region above the bearing points 38b, 40b of the seat structure elements 26b, 28b. The locking unit 88b is preferably arranged substantially, that is to say to a large extent, above the armrest height X.

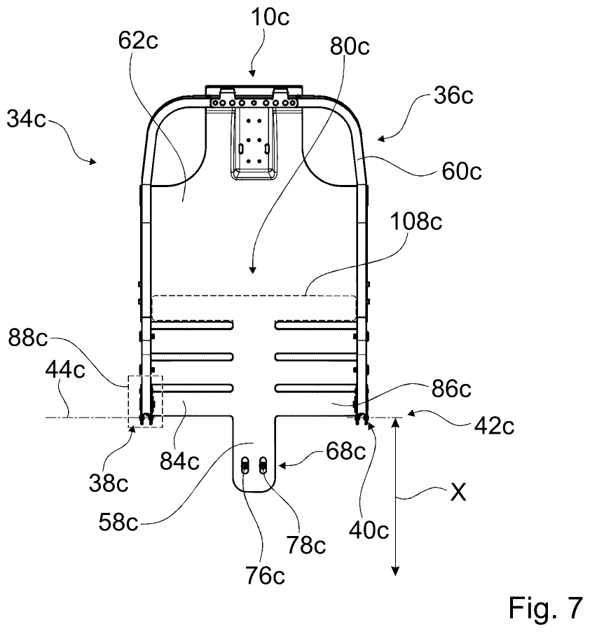

FIG. 7 shows a third exemplary embodiment of an aircraft seat device according to the invention. The aircraft seat device is part of a partially illustrated aircraft seat 10c. The aircraft seat 10c is formed substantially identically to the aircraft seat of the first exemplary embodiment from FIGS. 1-4 and will therefore not be described in more detail here. The aircraft seat device has a mounting unit which is not illustrated in more detail. The aircraft seat device has two seat structure elements which are connected to the mounting unit and are not illustrated in more detail and are embodied as seat dividers. The seat structure elements extend as far as an armrest height X of the aircraft seat 10c.

The aircraft seat device comprises a backrest 34c. The backrest 34c forms a backrest contact surface. The backrest 34c is attached to the seat structure elements. The backrest 34c is embodied pivotably. The backrest 34c is configured to be pivoted between an upright sitting position and a comfort position. The backrest 34c has a pivotable backrest element 36c. The backrest 34c is designed as a backrest with a high backrest pivot point. The backrest pivot point is formed by an axis of rotation 44c of a bearing device 42c. The pivotable backrest element 36c is pivotably attached to the seat structure elements. The seat structure elements each have a bearing point 38c, 40c for supporting the backrest 34c. The pivotable backrest element 36c has a backrest frame 60c. The backrest frame 60c forms a load-bearing structure of the pivotable backrest element 36c. The pivotable backrest element 36c has a shell element 62c. The shell element 62c is embodied as a plate-like element. The shell element 62c is formed from a fiber-reinforced plastic. The shell element 62c is formed, for example, from a GRP or a CFRP. The shell element 62c is configured to form the backrest contact surface of the pivotable backrest element 36c. The shell element 62c is fixedly connected to the backrest frame 60c of the pivotable backrest element 36c. The shell element 62c preferably forms a backrest contour of the pivotable backrest element 36c. The backrest 34c has a lower backrest element which is not illustrated in more detail. The lower backrest element is likewise formed by a shell element.

The aircraft seat device has a restoring module 56c. The restoring module 56c is configured to restore the backrest 34c from the comfort position into an upright sitting position. The restoring module 56c is configured to restore the pivotable backrest element 36c. The restoring module 56c is configured to restore the backrest 34c, in particular to restore the pivotable backrest element 36c, in order to provide a restoring force. The restoring module 56c has a spring element 58 c for providing a restoring force. The spring element 58c is embodied as a leaf spring element. In contrast to the first exemplary embodiment, the spring element 58c embodied as a leaf spring element is at least partially formed in one piece with the pivotable backrest element 36c. The spring element 58c embodied as a leaf spring element is formed in one piece with the shell element 62c of the pivotable backrest element 36c. The spring element 58c embodied as a leaf spring element is formed by a central region 80c of the shell element 62c. The spring element 58c embodied as a leaf spring element is integrated into the central region 80c of the shell element 62c. The spring element 58c embodied as a leaf spring element is embedded in fiber-reinforced layers of the shell element 62c. The spring element 58c embodied as a leaf spring element is preferably formed as a leaf spring element inserted into the shell element 62c in a production method. In principle, however, it would also be conceivable for the spring element 58c embodied as a leaf spring element to be formed by the fiber layers of the shell element 62c in the central region 80c itself.

At an upper end, the spring element 58c formed in one piece with the shell element 62c can form a transverse stiffening element 108c. The transverse stiffening element 108c is formed in one piece with the spring element 58c and thus the shell element 62c. The transverse stiffening element 108c, like the transverse beam of the first exemplary embodiment, is configured for better introduction of the restoring force into the pivotable backrest element 36c. In this exemplary embodiment, the pivotable backrest element 36c preferably has no separate transverse beam. In principle, it would also be conceivable for the spring element 58c embodied as a leaf spring element not to have a transverse stiffening element 108c.

The pivotable backrest element 36c has, in a lower region, elastic ribs 84c, 86c which each extend laterally outward from the central region 80c. The outwardly extending elastic ribs 84c, 86c can preferably likewise be formed in one piece with the spring element 58c embodied as a leaf spring element. For attaching the spring element 58c embodied as a leaf spring element to the lower backrest element, the restoring module 56c has a fastening unit 68c which is embodied in the same way as in the first exemplary embodiment. The fastening unit 68c is formed at least by through-grooves 76c, 78c embodied as elongated holes in a lower end of the spring element 58c.

The restoring module 56c has a locking unit which is not illustrated in more detail here and is formed substantially in the same way as in the preceding exemplary embodiments. The locking unit is preferably arranged functionally between the pivotable backrest element 36c, in particular the backrest frame 60c, and one of the seat structure elements. The locking unit is preferably arranged in a region above the bearing points of the seat structure elements. The locking unit is preferably arranged substantially, that is to say to a large extent, above the armrest height X.

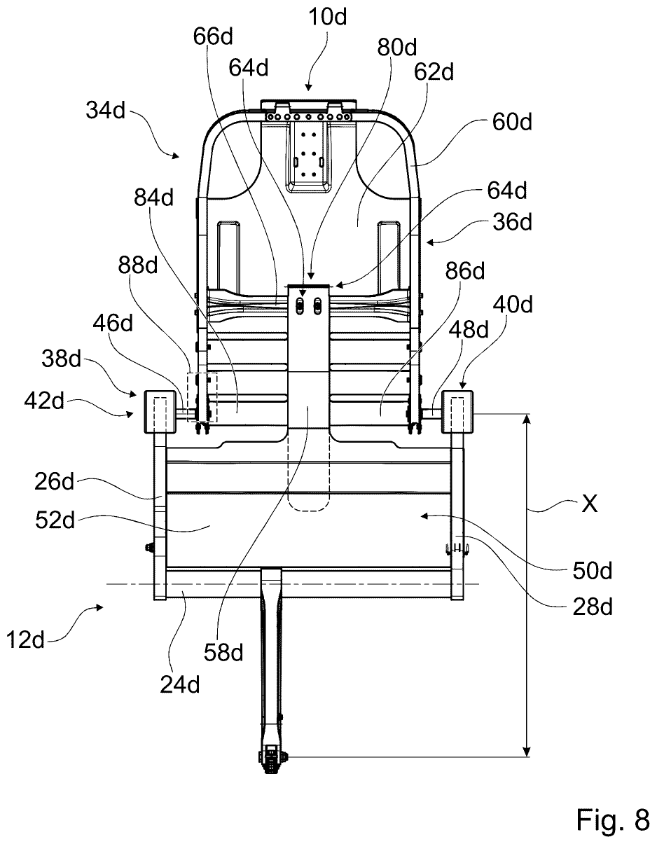

FIG. 8 shows a fourth exemplary embodiment of an aircraft seat device according to the invention. The aircraft seat device is part of a partially illustrated aircraft seat 10d. The aircraft seat device has a mounting unit 12d. The aircraft seat 10d can be mounted on the cabin floor of the aircraft cabin by means of the mounting unit 12d. The mounting unit 12d has two transverse beams 24d. The aircraft seat device has two seat structure elements 26d, 28d. The two seat structure elements 26d, 28d are each arranged on one side of a seat region 30d of the aircraft seat device. The two seat structure elements 26d, 28d are each arranged laterally with respect to a seat region 30d which the aircraft seat 10d forms. The seat structure elements 26d, 28d are embodied as seat dividers. The seat structure elements 26d, 28d are arranged on the transverse beams 24d. The seat structure elements 26d, 28d are embodied in a substantially L-shaped manner. The seat structure elements 26d, 28d thus extend upwards in their rear region, away from the mounting unit 12d, in particular the mounting plane. The seat structure elements 26d, 28d extend upwards in their rear region substantially as far as an armrest height X. The seat structure elements 26d, 28d extend as far as an armrest height X of the aircraft seat 10d.

The aircraft seat device comprises a backrest 34d. The backrest 34d is arranged pivotably with respect to the mounting unit 12d. The backrest 34d is attached to the seat structure elements 26d, 28d. The backrest 34d is configured to be pivoted between an upright sitting position and a comfort position. The backrest 34d has a pivotable backrest element 36d. The pivotable backrest element 36d is pivotably supported on the mounting unit 12d. The seat structure elements 26d, 28d each have a bearing point 38d, 40d for supporting the pivotable backrest element 36d. The aircraft seat device has a bearing device 42d. The bearing device 42d is configured to support the backrest 34d pivotably between the upright sitting position and the comfort position. The bearing device 42d is configured to support the pivotable backrest element 36d pivotably between the upright sitting position and the comfort position. The bearing device 42d forms the axis of rotation 44d. The bearing device 42d has two bearing bolts 46d, 48d. The bearing bolts 46d, 48d form the axis of rotation 44d. The bearing bolts 46d, 48d are each connected to one of the bearing points 38d, 40d of one of the seat structure elements 26d, 28d. The backrest 34d is designed as a backrest with a high backrest pivot point. The backrest pivot point, that is to say the axis of rotation 44d of the bearing device 42d, is arranged above a knee region 50d of the aircraft seat 10d. In order to form the high backrest pivot point, the seat structure elements 26d, 28d form their bearing points 38d, 40d for supporting the backrest 34d in a high region. The bearing points 38d, 40d of the seat structure elements 26d, 28d are arranged above the knee region 50d. The bearing points 38d, 40d of the seat structure elements 26d, 28d are arranged at the armrest height X.

The pivotable backrest element 36d has a backrest frame 60d. The backrest frame 60d forms a load-bearing structure of the pivotable backrest element 36d. The pivotable backrest element 36d has a shell element 62d. The shell element 62d is formed from a fiber-reinforced plastic. The shell element 62d is fixedly connected to the backrest frame 60d of the pivotable backrest element 36d. The shell element 62d of the pivotable backrest element 36d has a central region 80d. The pivotable backrest element 36d has, in a lower region, elastic ribs 84d, 86d which each extend laterally outward from the central region 80d. The elastic ribs 84d, 86d are preferably formed in one piece with the shell element 62d, in particular with the central region 80d.

The backrest 34d has a lower backrest element 52d. The lower backrest element 52d forms a lower region of the backrest 34d. The lower backrest element 52d forms the backrest contact surface in the lower region of the backrest 34d. The lower backrest element 52d is fastened fixedly to the seat structure elements 26d, 28d. The lower backrest element 52d extends substantially between a height of the transverse beams 22d, 24d of the mounting unit 12d and a lower end of the pivotable backrest element 36d. The lower backrest element 52d is formed by a shell element. The lower backrest element 52d is formed by a shell composed of a fiber-reinforced plastic.

The aircraft seat device has a restoring module 56d. The restoring module 56d is configured to restore the backrest 34d from the comfort position into an upright sitting position. The restoring module 56d is configured to restore the pivotable backrest element 36d. The restoring module 56d is configured to restore the backrest 34d, in particular to restore the pivotable backrest element 36d, in order to provide a restoring force. The restoring module 56d has a spring element 58d for providing a restoring force. The spring element 58d is embodied as a leaf spring element. In contrast to the preceding exemplary embodiments, the spring element 58d embodied as a leaf spring element is at least partially formed in one piece with the lower backrest element 52d.

The spring element 58d embodied as a leaf spring element is formed in one piece with the lower backrest element 52d embodied as a shell element. The spring element 58d embodied as a leaf spring element is formed by a central region of the lower backrest element 52d. The spring element 58d embodied as a leaf spring element is partially integrated into the lower shell element. The spring element 58d embodied as a leaf spring element is embedded in fiber-reinforced layers of the lower backrest element 52d embodied as a shell element. The spring element 58d embodied as a leaf spring element is preferably formed as a leaf spring element inserted into the lower backrest element 52d in a production method. The spring element 58d embodied as a leaf spring element extends from the lower backrest element 52d into a center of the pivotable backrest element 36d.

For attaching the spring element 58d embodied as a leaf spring element to the pivotable backrest element 36d, the restoring module 56d has a first fastening unit 64d. The pivotable backrest element 36d has a transverse beam 66d. The transverse beam 66d is arranged in a region above the bearing points 38d, 40d. The spring element 58d embodied as a leaf spring element is attached directly to the transverse beam 66d via the fastening unit 64d. The spring element 58d embodied as a leaf spring element is connected axially movably to the transverse beam 66d. The spring element 58d embodied as a leaf spring element has two through-grooves embodied as elongated holes via which the spring element 58d is displaceably connected to the transverse beam 66d via two fastening elements, for example screws, of the fastening unit 64d. The first fastening unit 64d for attaching the spring element 58d embodied as a leaf spring element can preferably be embodied equivalently to the second fastening unit of the first exemplary embodiment for attaching the spring element embodied as a leaf spring element to the lower backrest element.

The restoring module 56d has a locking unit 88d. The locking unit 88d is configured to lock or unlock the restoring module 56d. The locking unit 88d is configured to lock the backrest 34d, that is to say the pivotable backrest element 36d, at least in the upright sitting position and in the comfort position. The locking unit 88d is preferably arranged functionally between the pivotable backrest element 36d, in particular the backrest frame 60d, and one of the seat structure elements 26d, 28d. The locking unit 88d is arranged above the knee region 50d of the backrest 34d. The locking unit 88d is preferably arranged in a region above the bearing points 38d, 40d of the seat structure elements 26d, 28d. The locking unit 88d is preferably arranged substantially, that is to say to a large extent, above the armrest height X.

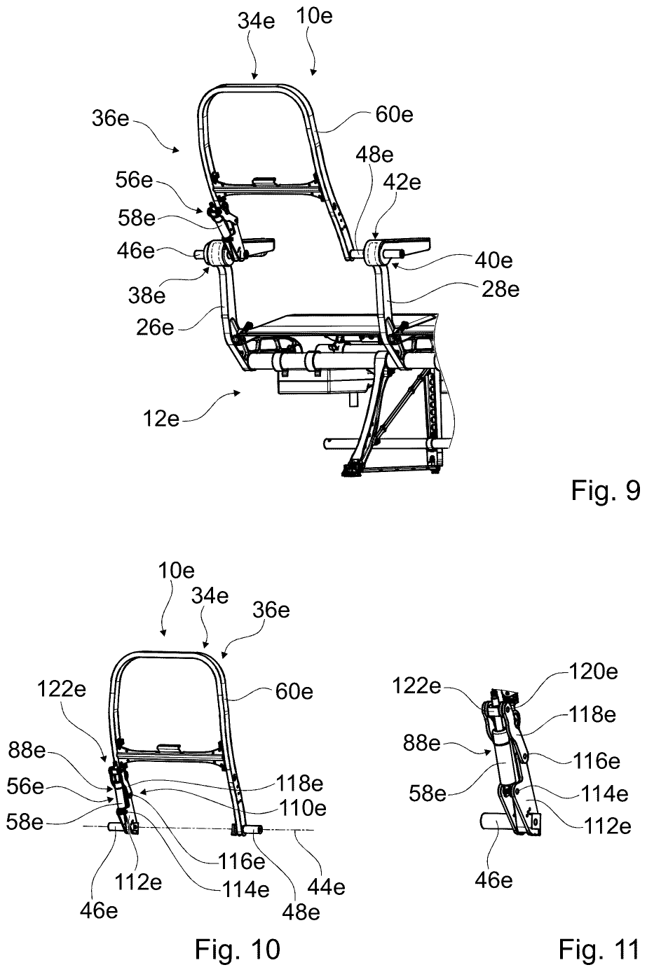

FIGS. 9 to 11 show a fifth exemplary embodiment of an aircraft seat device according to the invention. The aircraft seat device is part of a partially illustrated aircraft seat 10e. The aircraft seat device has a mounting unit 12e. The aircraft seat 10e can be mounted on the cabin floor of the aircraft cabin by means of the mounting unit 12e. The mounting unit 12e has two transverse beams 24e. The aircraft seat device has two seat structure elements 26e, 28e. The two seat structure elements 26e, 28e are each arranged on one side of a seat region 30e of the aircraft seat device. The two seat structure elements 26e, 28e are each arranged laterally with respect to a seat region 30e which the aircraft seat 10e forms. The seat structure elements 26e, 28e are embodied as seat dividers. The seat structure elements 26e, 28e are arranged on the transverse beams 24e. The seat structure elements 26e, 28e are embodied in a substantially L-shaped manner. The seat structure elements 26e, 28e thus extend upwards in their rear region, away from the mounting unit 12e, in particular the mounting plane. The seat structure elements 26e, 28e extend upwards in their rear region substantially as far as an armrest height X. The seat structure elements 26e, 28e extend as far as an armrest height X of the aircraft seat 10e.

The aircraft seat device comprises a backrest 34e. The backrest 34e is arranged pivotably with respect to the mounting unit 12e. The backrest 34e is attached to the seat structure elements 26e, 28e. The backrest 34e is configured to be pivoted between an upright sitting position and a comfort position. The backrest 34e has a pivotable backrest element 36e. The pivotable backrest element 36e is pivotably supported on the mounting unit 12e. The seat structure elements 26e, 28e each have a bearing point 38e, 40e for supporting the pivotable backrest element 36e.

The aircraft seat device has a bearing device 42e. The bearing device 42e is configured to support the backrest 34e pivotably between the upright sitting position and the comfort position. The bearing device 42e is configured to support the pivotable backrest element 36e pivotably between the upright sitting position and the comfort position. The bearing device 42e forms an axis of rotation 44e. The bearing device 42e has two bearing bolts 46e, 48e.

The bearing bolts 46e, 48e form the axis of rotation 44e. The bearing bolts 46e, 48e are each connected to one of the bearing points 38e, 40e of one of the seat structure elements 26e, 28e. The backrest 34e is designed as a backrest with a high backrest pivot point. The backrest pivot point, that is to say the axis of rotation 44e of the bearing device 42e, is arranged above a knee region 50e of the aircraft seat 10e. In order to form the high backrest pivot point, the seat structure elements 26e, 28e form their bearing points 38e, 40e for supporting the backrest 34e in a high region. The bearing points 38e, 40e of the seat structure elements 26e, 28e are arranged above the knee region 50e. The bearing points 38e, 40e of the seat structure elements 26e, 28e are arranged at the armrest height X.

The pivotable backrest element 36e has a backrest frame 60e. The backrest frame 60e forms a load-bearing structure of the pivotable backrest element 36e. The pivotable backrest element 36e can preferably be designed similarly to those of the first two exemplary embodiments and have a shell element or a fabric. The backrest 34e additionally has a lower backrest element which is not illustrated in more detail here and forms a lower region of the backrest 34e.

The aircraft seat device has a restoring module 56e. The restoring module 56e is configured to restore the backrest 34e from the comfort position into an upright sitting position. The restoring module 56e is configured to restore the pivotable backrest element 36e. The restoring module 56e is configured to restore the backrest 34e, in particular to restore the pivotable backrest element 36e, in order to provide a restoring force. The restoring module 56e has a spring element 58e for providing a restoring force. In contrast to the preceding exemplary embodiments, the spring element 58e is designed as a gas pressure spring. The spring element 58e designed as a gas pressure spring is configured to provide the restoring force of the restoring module 56e. The spring element 58e designed as a gas pressure spring is arranged above the bearing points 38e, 40e of the seat structure elements 26e, 28e.

The restoring module 56e has a lever gear 110e. The lever gear 110e is configured to convert a spring force of the spring element 58e designed as a gas pressure spring into a pivoting movement of the pivotable backrest element 36e. The lever gear 110e has a basic holding element 112e. The basic holding element 112e is rigidly and rotationally fixedly connected to the mounting unit 12e. The basic holding element 112e is preferably rotationally fixedly connected to the seat structure element 26e. The basic holding element 112e is in particular rotationally fixedly attached to the seat structure element 26e via a bearing bolt 46e of the bearing device 42e. The basic holding element 112e has a first fastening receptacle 114e. The spring element 58e designed as a gas pressure spring is pivotably supported at a first end to the first fastening receptacle 114e. The basic holding element 112e has a second fastening receptacle 116e. The lever gear 110e has a lever element 118e. The lever element 118e is pivotably attached to the basic holding element 112e via the second fastening receptacle 116e. The lever element 118e of the lever gear 110e is pivotably connected at its first end to the basic holding element 112e via the second fastening receptacle 116e. In the mounted state, in the upright sitting position of the backrest 34e, the lever element 118e extends upward away from the mounting plane (see FIGS. 9 and 10). The spring element 58e designed as a gas pressure spring is rotatably connected at its second end to the second end of the lever element 118e via a bearing point 120e.

The lever gear 110e has a coupling element 122e which couples the lever gear 110e to the pivotable backrest element 36e. The coupling element 122e is attached at its first end to the bearing point 120e. The coupling element 122e is rotatably connected at its first end jointly to the second end of the spring element 58e designed as a gas pressure spring and to the second end of the lever element 118e. The coupling element 122e is rotatably connected at its second end to the pivotable backrest element 36e. The coupling element 122e is preferably rotatably connected at its second end to the backrest frame 60e of the pivotable backrest element 36e via a bearing point which is not illustrated in more detail.

The restoring module 56e has a locking unit 88e. The locking unit 88e is configured to lock or unlock the restoring module 56e. The locking unit 88e is configured to lock the backrest 34e, that is to say the pivotable backrest element 36e, at least in the upright sitting position and in the comfort position. The locking unit 88e is configured to lock the spring element 58e embodied as a gas spring directly. In a locked state of the locking unit 88e, the spring element 58e embodied as a gas spring is locked and cannot provide any spring force. In an unlocked state of the locking unit 88e, the spring element 58e embodied as a gas spring is unlocked and can provide its spring force as a restoring force. The locking unit 88e is arranged in the spring element 58e embodied as a gas spring. The locking unit 88e is embodied internally in the spring element 58e embodied as a gas spring. The locking unit 88e is formed in one piece with the spring element 58e embodied as a gas spring.

If the pivotable backrest element 36e is pivoted rearward in its comfort position, the spring element 58e embodied as a gas spring is compressed. The lever element 118e and the spring element 58e embodied as a gas spring are likewise pivoted rearward in the comfort position of the pivotable backrest element 36e via the fastening receptacles 114e, 116e of the basic holding element 112e. If the spring element 58e embodied as a gas spring is now actuated, that is to say unlocked, the spring element 58e embodied as a gas spring presses the lever element 118e and therefore the pivotable backrest element 36e connected to the lever gear 110e via the coupling element 122e upward and therefore into its upright sitting position.

The entire lever gear 110e, the spring element 58e embodied as a gas spring, and the locking unit 88e embodied integrally with the spring element 58e are arranged above the armrest height X. The entire restoring module 56e is arranged above the bearing points 38e, 40e of the seat structure elements 26e, 28e for the pivotable backrest element 36e. The restoring module 56e is arranged completely above the knee region 50e of the backrest 34e. The entire restoring module 56e is arranged on one side on the pivotable backrest element 36e. The restoring module 56e is arranged merely on the side facing the left-hand seat structure element 26e. As a result, the restoring module 56e can be arranged in a particularly space-saving manner.

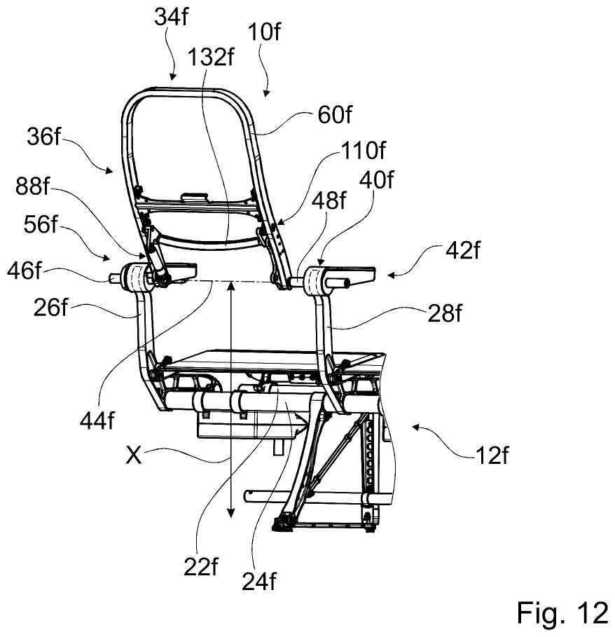

FIGS. 12 to 14 show a sixth exemplary embodiment of an aircraft seat device according to the invention. The aircraft seat device is part of a partially illustrated aircraft seat 10f. The aircraft seat device has a mounting unit 12f. The aircraft seat 10f can be mounted on the cabin floor of an aircraft cabin by means of the mounting unit 12f. The mounting unit 12f has two transverse beams 22f, 24f. The aircraft seat device has two seat structure elements 26f, 28f. The two seat structure elements 26f, 28f are each arranged on one side of a seat region 30f of the aircraft seat device. The two seat structure elements 26f, 28f are each arranged laterally with respect to a seat region 30f which the aircraft seat 10f forms. The seat structure elements 26f, 28f are embodied as seat dividers. The seat structure elements 26f, 28f are arranged on the transverse beams 24f. The seat structure elements 26f, 28f are embodied in a substantially L-shaped manner. The seat structure elements 26f, 28f thus extend upwards in their rear region, away from the mounting unit 12f, in particular the mounting plane. The seat structure elements 26f, 28f extend upwards in their rear region substantially as far as an armrest height X. The seat structure elements 26f, 28f extend as far as an armrest height X of the aircraft seat 10f.

The aircraft seat device comprises a backrest 34f. The backrest 34f is arranged pivotably with respect to the mounting unit 12f. The backrest 34f is attached to the seat structure elements 26f, 28f. The backrest 34f is configured to be pivoted between an upright sitting position and a comfort position. The backrest 34f has a pivotable backrest element 36f. The pivotable backrest element 36f is pivotably supported on the mounting unit 12f. The seat structure elements 26f, 28f each have a bearing point 38f, 40f for supporting the pivotable backrest element 36f. The aircraft seat device has a bearing device 42f. The bearing device 42f is configured to support the backrest 34f pivotably between the upright sitting position and the comfort position. The bearing device 42f is configured to support the pivotable backrest element 36f pivotably between the upright sitting position and the comfort position. The bearing device 42f forms an axis of rotation 44f. The bearing device 42f has two bearing bolts 46f, 48f. The bearing bolts 46f, 48f form the axis of rotation 44f. The bearing bolts 46f, 48f are each connected to one of the bearing points 38f, 40f of one of the seat structure elements 26f, 28f. The backrest 34f is designed as a backrest with a high backrest pivot point. The backrest pivot point, that is to say the axis of rotation 44f of the bearing device 42f, is arranged above a knee region 50f of the aircraft seat 10f. In order to form the high backrest pivot point, the seat structure elements 26f, 28f form their bearing points 38f, 40f for supporting the backrest 34f in a high region. The bearing points 38f, 40f of the seat structure elements 26f, 28f are arranged above the knee region 50f. The bearing points 38f, 40f of the seat structure elements 26f, 28f are arranged at the armrest height X.

The pivotable backrest element 36f has a backrest frame 60f. The backrest frame 60f forms a load-bearing structure of the pivotable backrest element 36f. The pivotable backrest element 36f can preferably be designed similarly to those of the first two exemplary embodiments and have a shell element or a fabric. The backrest 34f additionally has a lower backrest element which is not illustrated in more detail here and forms a lower region of the backrest 34f.

The aircraft seat device has a restoring module 56f. The restoring module 56f is configured to restore the backrest 34f from the comfort position into an upright sitting position. The restoring module 56f is configured to restore the pivotable backrest element 36f. The restoring module 56f is configured to restore the backrest 34f, in particular to restore the pivotable backrest element 36f, in order to provide a restoring force. The restoring module 56f has a spring element 58f for providing a restoring force. As in the fifth exemplary embodiment of FIGS. 9 to 11, the spring element 58f is embodied as a gas spring. The spring element 58f designed as a gas pressure spring is configured to provide the restoring force of the restoring module 56f. The spring element 58f designed as a gas pressure spring is arranged above the bearing points 38f, 40f of the seat structure elements 26f, 28f.

The restoring module 56f has a lever gear 110f. The lever gear 110f is configured to convert a spring force of the spring element 58f designed as a gas pressure spring into a pivoting movement of the pivotable backrest element 36f. In contrast to the fifth exemplary embodiment, the lever gear 110f is arranged on both sides of the backrest frame 60f. The lever gear 110f is arranged on both lateral frame elements of the backrest frame 60f. In this case, the lever gear 110f is arranged on an inner side of the two lateral frame elements of the backrest frame 60f. The lever gear 110f has two eccentric elements 124f, 126f. The eccentric elements 124f, 126f are in each case pivotably attached to an inner side of a lateral frame element of the backrest frame 60f. The eccentric elements 124f, 126f are arranged coaxially with respect to one another. The eccentric elements 124f, 126f each have a first point 128f, 130f.

The lever gear 110f has a torsion tube 132f. The torsion tube 132f connects the two eccentric elements 124f, 126f to one another. The torsion tube 132f is in each case rotationally fixedly attached to the first attachment point 128f, 130f of the eccentric elements 124f, 126f. The torsion tube 132f connects the eccentric elements 124f, 126f at their first attachment points 128f, 130f. The first eccentric element 124f is arranged on the left-hand side of the pivotable backrest element 36f, which side faces the left-hand seat structure element 26f. The first eccentric element 124f has a second attachment point 134f via which the spring element 58f configured as a gas pressure spring is attached to the first eccentric element 124f. The spring element 58f configured as a gas pressure spring is attached by its second end to the second attachment point 134f of the first eccentric element 124f. The spring element 58f configured as a gas pressure spring is rotatably attached at a first end to the mounting unit 12f. The spring element 58f configured as a gas pressure spring is preferably rotatably attached at its first end to a bearing bolt 46f of the bearing device 42f.

The second eccentric element 126f is arranged on the right-hand side of the pivotable backrest element 36f, which side faces the right-hand seat structure element 28f. The second eccentric element 126f likewise has a second attachment point 136f. The lever gear 110f has a lever element 138f which is pivotably attached to the second attachment point 136f of the second eccentric element 126f. The lever element 138f is pivotably attached at its second end to the attachment point 136f of the second eccentric element 126f. The lever element 138f is rotatably attached at its first end to the mounting unit 12f. The lever element 138f is preferably rotatably attached at its first end to the bearing bolt 48f of the bearing device 42f.

The eccentric elements 124f, 126f rotate as a result of an elongation or shortening of the spring element 58f designed as a gas pressure spring. If the pivotable backrest element 36f is pivoted rearward in its comfort position, the spring element 58f designed as a gas spring is compressed. As a result, the eccentric elements 124f, 126f are pivoted. If the spring element 58f designed as a gas spring is now actuated, that is to say unlocked, the spring element 58f designed as a gas spring presses via the second attachment point 134f onto the first eccentric element 124f and rotates the latter and therefore the pivotable backrest element 36f into its upright sitting position. The restoring force of the spring element 58f designed as a gas pressure spring is transmitted by the torsion tube 132f to the opposite side of the backrest frame 60f. As a result, the pivotable backrest element 36f is pressed uniformly into the upright sitting position on both sides.

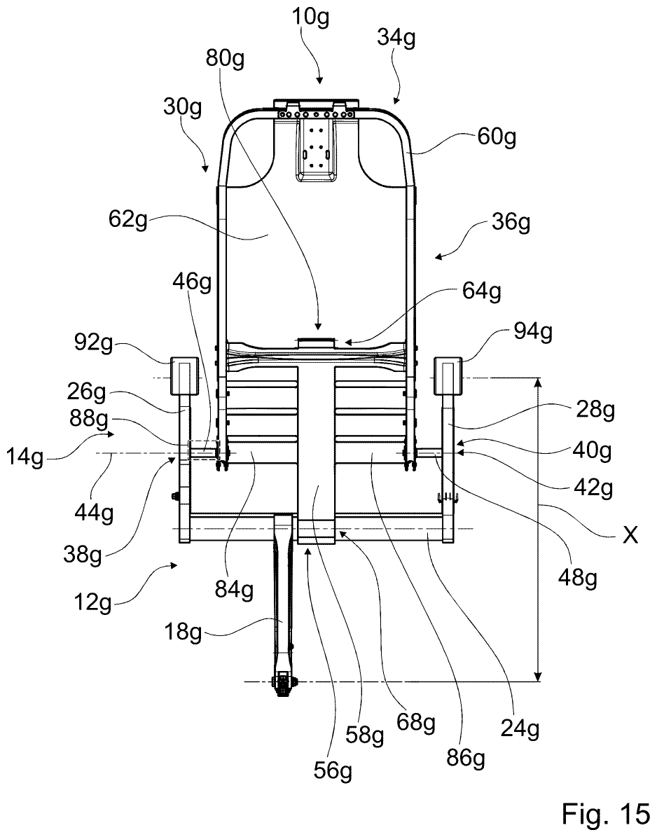

The entire lever gear 110f, the spring element 58f designed as a gas pressure spring, and a locking unit 88f embodied integrally with the spring element 58f are arranged above the armrest height X. The entire restoring module 56f is arranged above the bearing points 38f, 40f of the seat structure elements 26f, 28f for the pivotable backrest element 36f. The restoring module 56f is arranged completely above the knee region 50f of the backrest 34f. FIG. 15 shows a seventh exemplary embodiment of an aircraft seat device according to the invention. The aircraft seat device is part of a partially illustrated aircraft seat 10g. The aircraft seat device has a mounting unit 12g. The aircraft seat 10g can be mounted on the cabin floor of the aircraft cabin by means of the mounting unit 12g. The mounting unit 12g has two transverse beams 24g. The aircraft seat device has two seat structure elements 26g, 28g. The two seat structure elements 26g, 28g are each arranged on one side of a seat region 30g of the aircraft seat device. The two seat structure elements 26g, 28g are each arranged laterally with respect to a seat region 30g which the aircraft seat 10g forms. The seat structure elements 26g, 28g are embodied as seat dividers. The seat structure elements 26g, 28g are embodied in a substantially L-shaped manner. The seat structure elements 26g, 28g each have a first partial region which is oriented substantially horizontally in the mounted state. The seat structure elements 26g, 28g each have a second partial region which is oriented substantially vertically in the mounted state. The second partial region of the seat structure elements 26g, 28g is arranged in a rear region of the aircraft seat 10g. The seat structure elements 26g, 28g are arranged on the transverse beams 24g. The seat structure elements 26g, 28g thus extend upwards in their rear region, away from the mounting unit 12g, in particular the mounting plane. The seat structure elements 26g, 28g extend upwards in their rear region substantially as far as an armrest height X. The seat structure elements 26g, 28g extend as far as an armrest height X of the aircraft seat 10g.

The aircraft seat device comprises a backrest 34g. The backrest 34g is arranged pivotably with respect to the mounting unit 12g. The backrest 34g is attached to the seat structure elements 26g, 28g. The backrest 34g is configured to be pivoted between an upright sitting position and a comfort position. The backrest 34g has a pivotable backrest element 36g. In contrast to the preceding exemplary embodiments, the backrest 34g is designed as a backrest with a lower backrest pivot point. The backrest 34g preferably has no lower backrest element which is rigidly connected to the seat structure elements 26g, 28g. The pivotable backrest element 36g extends as far as a region of the seat bottom of the aircraft seat 10g. The pivotable backrest element 36g extends as far as a region below a seat surface formed by the seat bottom. The pivotable backrest element 36g is pivotably supported in a region below the armrest height X.

The pivotable backrest element 36g is pivotably attached to the seat structure elements 26g, 28g. The seat structure elements 26g, 28g each have a bearing point 38g, 40g for supporting the pivotable backrest element 36g. In order to form the lower backrest pivot point, the seat structure elements 26g, 28g form their bearing points for supporting the pivotable backrest element 36g in a lower region. The bearing points 38g, 40g of the seat structure elements 26g, 28g are preferably arranged in a lower third of the seat structure elements 26g, 28g, in particular in a lower third of the second partial region of the seat structure elements 26g, 28g. The bearing points 38g, 40g of the seat structure elements 26g, 28g are arranged in a knee region 50g of the backrest 34g. The bearing points 38g, 40g of the seat structure elements 26g, 28g are arranged below the armrest height X.

The aircraft seat device has a bearing device 42g. The bearing device 42g is configured to support the pivotable backrest element 36g pivotably between the upright sitting position and the comfort position. The bearing device 42g forms an axis of rotation 44g. The axis of rotation 44g for supporting the pivotable backrest element 36g is arranged below the armrest height X. The bearing device 42g has two bearing bolts 46g, 48g. The bearing bolts 46g, 48g form the axis of rotation 44g. The bearing bolts 46g, 48g are each connected to one of the bearing points 38g, 40g of one of the seat structure elements 26g, 28g.

The pivotable backrest element 36g has a backrest frame 60g. The backrest frame 60g extends as far as a region below the bearing points 38g, 40g of the seat structure elements 26g, 28g. The pivotable backrest element 36g has a shell element 62g which is fixedly connected to the backrest frame 60g of the pivotable backrest element 36g. The shell element 62g of the pivotable backrest element 36g has a central region 80g and, in a lower region, elastic ribs 84g, 86g which each extend laterally outward from the central region 80g. The aircraft seat device has a restoring module 56g. The restoring module 56g is configured to restore the backrest 34g from the comfort position into an upright sitting position. The restoring module 56g is configured to restore the pivotable backrest element 36g. The restoring module 56g has a spring element 58g for providing a restoring force. The spring element 58g is embodied as a leaf spring element. The spring element 58g embodied as a leaf spring element is arranged functionally between the pivotable backrest element 36g and the mounting unit 12g.

The spring element 58g embodied as a leaf spring element is attached by its first, lower end, in contrast to the other exemplary embodiments, directly to the mounting unit 12g, in particular to the rear transverse beam 24g. The spring element 58g embodied as a leaf spring element is braced by its lower end on the rear transverse beam 24g of the mounting unit. For attaching the spring element 58g embodied as a leaf spring element to the rear transverse beam 24g, the restoring module 56g has a fastening unit 68g. The spring element 58g embodied as a leaf spring element is fixedly attached to the mounting unit 12g via the fastening unit 68g. The fastening unit 68g preferably has a clamp element which encloses the rear transverse beam 24g and is thus fixedly attached to the transverse beam 24g. The spring element 58g embodied as a leaf spring element is preferably attached movably in at least one vertical direction to the rear transverse beam 24g via the fastening unit 68g. The spring element 58g embodied as a leaf spring element is attached by a second, upper end to the pivotable backrest element 36g. For attaching the spring element 58g embodied as a leaf spring element to the pivotable backrest element 36g, the restoring module 56g has a fastening unit 64g.

The restoring module 56g has a locking unit 88g. The locking unit 88g is configured to lock or unlock the restoring module 56g. The locking unit 88g is preferably arranged in a region above the bearing points 38g, 40g of the seat structure elements 26g, 28g. The entire restoring module 56g, except for the partial region of the spring element 58g embodied as a leaf spring which extends as far as the transverse beam 24g of the mounting unit 12g, is arranged above the bearing points 38g, 40g of the seat structure elements 26g, 28g, that is to say above the axis of rotation 44g of the pivotable backrest element 36g.

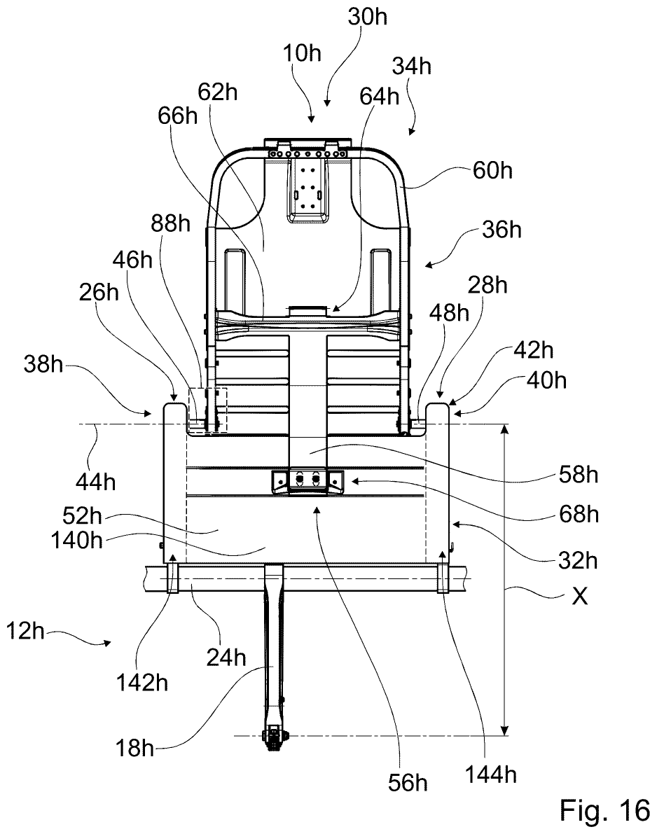

FIG. 16 shows an eighth exemplary embodiment of an aircraft seat device according to the invention. The aircraft seat device is part of a partially illustrated aircraft seat 10h. The aircraft seat device has a mounting unit 12h. The aircraft seat 10h can be mounted on the cabin floor of the aircraft cabin by means of the mounting unit 12h. The mounting unit 12h has two transverse beams 24h. The aircraft seat device has two seat structure elements 26h, 28h. The two seat structure elements 26h, 28h are each arranged on one side of a seat region 30h of the aircraft seat device. The two seat structure elements 26h, 28h are each arranged laterally with respect to a seat region 30h which the aircraft seat 10h forms. The pivotable backrest element 36h is pivotably attached to the seat structure elements 26h, 28h. The seat structure elements 26h, 28h each have a bearing point 38h, 40h for supporting the pivotable backrest element 36h.

The aircraft seat device comprises a seat bottom 32h. The seat bottom 32h has a load-bearing main body. The seat bottom 32h additionally has an upholstery element which is attached to the main body. The seat bottom 32h is attached to the mounting unit 12h. The aircraft seat device comprises a backrest 34h. The backrest 34h is arranged pivotably with respect to the mounting unit 12h. The backrest 34h is attached to the seat structure elements 26h, 28h. The backrest 34h is designed as a backrest with a high backrest pivot point. The backrest 34h has a lower backrest element 52h. The lower backrest element 52h forms a lower region of the backrest 34h. The lower backrest element 52h forms the backrest contact surface in the lower region of the backrest 34h. The lower backrest element 52h is rigidly connected to the mounting unit 12h. The backrest 34h is configured to be pivoted between an upright sitting position and a comfort position. The backrest 34h has a pivotable backrest element 36h. The pivotable backrest element 36h has a backrest frame 60h. The pivotable backrest element 36h has a shell element 62h. The pivotable backrest element 36h is formed substantially identically to the first exemplary embodiment and will therefore not be described in detail here.

In contrast to the preceding exemplary embodiments, the seat structure elements 26h, 28h are not embodied as seat dividers. The aircraft seat device has a seat shell element 140h.

The seat shell element 140h forms the lower backrest element 52h and the main body of the seat bottom 32h in one piece. The seat shell element 140h forms the main body of the seat bottom 32h in a lower, front region. In a rear region, the seat shell element 140h forms the lower backrest element 52h. The seat shell element 140h is formed from a fiber-reinforced plastic. The seat shell element 140h is preferably formed from a CFRP or a GRP. In principle, it is also conceivable for the seat shell element 140h to be formed from another suitable fiber-reinforced plastic. The seat shell element 140h is embodied in a substantially L-shaped manner in a side view. In contrast to the preceding exemplary embodiments, the seat structure elements 26h, 28h are formed in one piece with the seat shell element 140h. The seat structure elements 26h, 28h are at least partially formed from the lower backrest element 52h and the main body of a seat bottom 32h. The seat shell element 140h has side regions 142h, 144h. As viewed in the transverse direction, the side regions 142h, 144h each form a lateral end of the seat shell element 140h. The seat structure elements 26h, 28h are formed in the side regions 142h, 144h of the seat shell element 140h. The side regions 142h, 144h of the seat shell element 140h each form one of the seat structure elements 26h, 28h. Preferably, the seat shell element 140h has in each case at least one reinforcing element in its side regions 142h, 144h in order to form the seat structure elements 26h, 28h. The reinforcing elements can be embodied, for example, as inserts which are inserted into the side regions 142h, 144h of the seat shell element 140h. The reinforcing elements embodied as inserts could be embodied, for example, from a metal, such as an aluminum or a magnesium. In principle, it would also be conceivable for the reinforcing elements to be formed from local reinforcements from a CFRP or GRP.

The seat shell element 140h extends in its side regions 142h, 144h, in which it forms the seat structure elements 26h, 28h, as far as an upper edge of the lower backrest element 52h formed by it. The seat shell element 140h extends in its side regions 142h, 144h, in which it forms the seat structure elements 26h, 28h, as far as an armrest height X. The seat shell element 140h forms in its side regions 142h, 144h in each case in the upper end regions the bearing points 38h, 40h of the seat structure elements 26h, 28h. The seat shell element 140h forms in each case in the upper end regions of its side regions 142h, 144h the bearing points 38h, 40h of the seat structure elements 26h, 28h, via which the pivotable backrest element 36h is pivotably supported. The pivotable backrest element 36h is directly pivotably connected to the seat shell element 140h via the bearing points 38h, 40h.

The aircraft seat device has a bearing device 42h. The bearing device 42h is configured to support the pivotable backrest element 36h pivotably between the upright sitting position and the comfort position. The bearing device 42h forms an axis of rotation 44h. The bearing device 42h has two bearing bolts 46h, 48h. The bearing bolts 46h, 48h are each connected to one of the bearing points 38h, 40h of the seat structure elements 26h, 28h formed by the seat shell element 140h. The bearing bolts 46h, 48h are fixedly connected to the seat shell element 140h. The pivotable backrest element 36h is directly pivotably attached to the seat shell element 140h via the bearing bolts 46h, 48h.

The seat shell element 140h is embodied in a wider manner than the pivotable backrest element 36h. The seat shell element 140h engages with its upper ends of the side regions 142h, 144h, in which the bearing points 38h, 40h are arranged, around the pivotable backrest element 36h, in particular the backrest frame 60h thereof, at its lower end. The bearing bolts 46h, 48h each extend inwards from the side regions 142h, 144h of the seat shell element 140h in the direction of the backrest frame 60h of the pivotable backrest element 36h. The pivotable backrest element 36h is pivotably attached to the bearing bolts 46h, 48h.

The aircraft seat device has a restoring module 56h. The restoring module 56h is configured to restore the backrest 34h from the comfort position into an upright sitting position. The restoring module 56h is configured to restore the pivotable backrest element 36h. The restoring module 56h is configured to restore the backrest 34h, in particular to restore the pivotable backrest element 36h, in order to provide a restoring force. The restoring module 56h has a spring element 58h for providing a restoring force. The spring element 58h is embodied as a leaf spring element. The restoring module 56h can preferably be embodied as in one of the preceding exemplary embodiments. By way of example, the restoring module 56h is formed substantially identically to the first exemplary embodiment.

The spring element 58h embodied as a leaf spring element is arranged functionally between the seat shell element 140h and the pivotable backrest element 36h. The spring element 58h embodied as a leaf spring element is attached by its first, lower end to the seat shell element 140h, in particular to the lower backrest element 52h formed by the seat shell element 140h. For attaching the spring element 58h embodied as a leaf spring element to the seat shell element 140h, the restoring module 56h has a fastening unit 68h. The spring element 58h embodied as a leaf spring element is movably attached to the seat shell element 140h via the fastening unit 68h. For attaching the spring element 58h embodied as a leaf spring element to the pivotable backrest element 36h, the restoring module 56h has a fastening unit 64h. The pivotable backrest element 36h has a transverse beam 66h. The spring element 58h embodied as a leaf spring element is attached directly to the transverse beam 66h via the fastening unit 64h.

The restoring module 56h has a locking unit 88h. The locking unit 88h is configured to lock or unlock the restoring module 56h. The locking unit 88h is preferably arranged functionally between the pivotable backrest element 36h, in particular the backrest frame 60h, and the seat shell element 140h. The locking unit 88h is arranged above a knee region 50h of the backrest 34h. The locking unit 88h is preferably arranged in a region above the bearing points 38h, 40h of the seat structure elements 26h, 28h formed by the seat shell element 140h. The locking unit 88h is preferably arranged substantially, that is to say to a large extent, above the armrest height X.

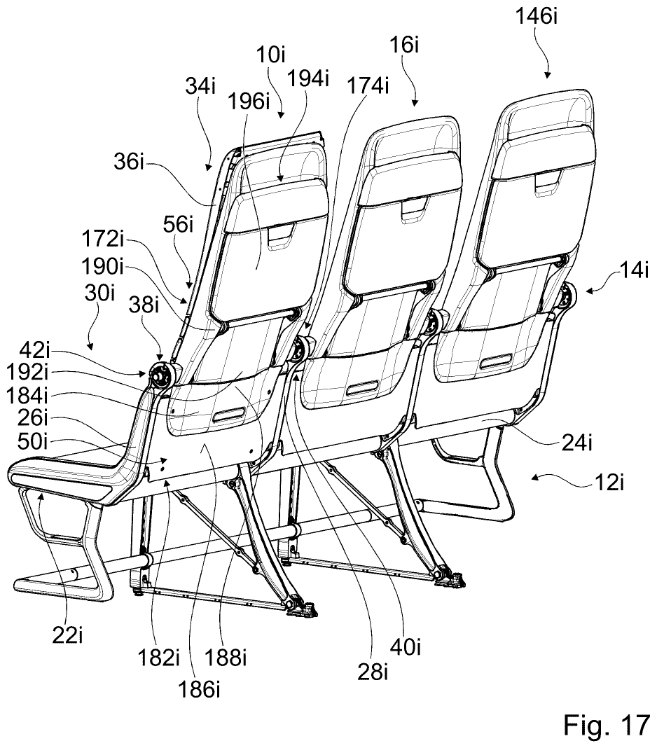

FIGS. 17 to 20 show a ninth exemplary embodiment of an aircraft seat device according to the invention. In this case, the aircraft seat device is part of an aircraft seat 10i. In a mounted state, the aircraft seat 10i is mounted in an aircraft cabin of an aircraft. The aircraft seat device has a mounting unit 12i. The aircraft seat 10i can be mounted on the cabin floor of the aircraft cabin by means of the mounting unit 12. The aircraft seat 10i is preferably formed as part of an aircraft seat row 14i which comprises more than one aircraft seat 10i.

By way of example, the aircraft seat row 14i with three aircraft seats 10i, 16i, 146i is shown in the figures. The aircraft seat row 14i shown by way of example has a second aircraft seat 16i and a third aircraft seat 146i. The second aircraft seat 16i is formed as a central seat of the aircraft seat row 14i and is arranged between the two other aircraft seats 16i, 146i. The further aircraft seats 16i, 146i of the aircraft seat row 14i are preferably formed substantially identically to the first aircraft seat 10i, for which reason only the one aircraft seat 10i will be described in more detail below.

The mounting unit 12i has two transverse beams 22i, 24i. The transverse beams 22i, 24i are embodied as support tubes. The transverse beams 22i, 24i extend at least substantially over an entire transverse extent of all the aircraft seats 10i of the aircraft seat row 14i. The aircraft seat device has two seat structure elements 26i, 28i. The two seat structure elements 26i, 28i are each arranged on one side of a seat region 30i of the aircraft seat device. The two seat structure elements 26i, 28i are each arranged laterally with respect to a seat region 30i which the aircraft seat 10i forms. The seat structure elements 26i, 28i are embodied as seat dividers. The seat structure elements 26i, 28i embodied as seat dividers are configured for the purpose of different components of the corresponding aircraft seat 10i, 16i, 146i being fastened thereto. The seat structure elements 26i, 28i thus extend upwards in their rear region, away from the mounting unit 12i, in particular the mounting plane. The seat structure elements 26i, 28i extend upwards in their rear region substantially as far as an armrest height X. The seat structure elements 26i, 28i extend as far as an armrest height X of the aircraft seat 10i.

The aircraft seat device comprises a backrest 34i. The backrest 34i is configured such that a person sitting on the aircraft seat 10i, whose part is the aircraft seat device, can rest his/her back on the backrest 34i. The backrest 34i is arranged pivotably with respect to the mounting unit 12i. The backrest 34i is attached to the seat structure elements 26i, 28i. The backrest 34i is configured to be pivoted between an upright sitting position and a comfort position. The backrest 34i has a pivotable backrest element 36i. The pivotable backrest element 36i is pivotably supported on the mounting unit 12i. The pivotable backrest element 36i is pivotably attached to the seat structure elements 26i, 28i. The seat structure elements 26i, 28i each have a bearing point 38i, 40i for supporting the backrest 34i. The bearing points 38i, 40i are configured such that the pivotable backrest element 36i is supported thereon.

The aircraft seat device has a bearing device 42i. The bearing device 42i is configured to support the backrest 34i pivotably between the upright sitting position and the comfort position. The bearing device 42i is configured to support the pivotable backrest element 36i pivotably between the upright sitting position and the comfort position. The bearing device 42i forms an axis of rotation 44i. The pivotable backrest element 36i is pivotable about the axis of rotation 44i by means of the bearing device 42i. The bearing device 42i has two bearing bolts 46i, 48i. The bearing bolts 46i, 48i form the axis of rotation 44i. The bearing bolts 46i, 48i are each connected to one of the bearing points 38i, 40i of one of the seat structure elements 26i, 28i.

The pivotable backrest element 36i has a backrest frame 60i. The backrest frame 60i forms a load-bearing structure of the pivotable backrest element 36i. The backrest frame 60i is embodied as a circumferential frame. The backrest frame 60i has two lateral frame elements and an upper frame element which connects the two lateral frame elements at an upper end of the backrest frame 60i. The lower end of the backrest frame 60i forms a lower end of the pivotable backrest element 36i. The bearing bolts 46i, 48i are each attached to the backrest frame 60i of the pivotable backrest element 36i at a lower end of the backrest frame 60i at the facing lateral frame element. The backrest 34i is designed as a backrest with a high backrest pivot point. The backrest pivot point, that is to say the axis of rotation 44i of the bearing device 42i, is arranged above a knee region 50i of the aircraft seat 10i. In order to form the high backrest pivot point, the seat structure elements 26i, 28i form their bearing points 38i, 40i for supporting the backrest 34i in a high region. The bearing points 38i, 40i of the seat structure elements 26i, 28i are arranged above the knee region 50i. The bearing points 38i, 40i of the seat structure elements 26i, 28i are arranged at the armrest height X.

The pivotable backrest element 36i has a shell element 62i. The shell element 62i is embodied as a plate-like element. The shell element 62i is formed from a fiber-reinforced plastic. The shell element 62i is formed, for example, from a GRP or a CFRP. The shell element 62i is configured to form the backrest contact surface of the pivotable backrest element 36i. The shell element 62i is arranged in an inner region of the pivotable backrest element 36i which is clamped by the backrest frame 60i. The shell element 62i is fixedly connected to the backrest frame 60i of the pivotable backrest element 36i. The shell element 62i is configured such that an upholstery element of the backrest 34i is attached thereto.

The pivotable backrest element 36i has, in a lower region, elastic ribs 84i, 86i which each extend laterally outward from the central region 80i. By way of example, three elastic ribs 84i, 86i are in each case illustrated per side in the exemplary embodiment. The elastic ribs 84i, 86i are each elastically deformable independently of one another. The elastic ribs 84i, 86i are preferably formed in one piece with the shell element 62i, in particular with the central region 80i. The shell element 62i forms the elastic ribs 84i, 86i in its lower region. The lower region is preferably formed approximately by a lower third of the shell element 62i. The shell element 62i has a plurality of slots 148i, 150i in its lower region in order to form the ribs 84i, 86i. The slots 148i, 150i each extend from a lateral outer edge of the shell element 62i as far as in front of the central region 80i. The slots 148i, 150i separate the elastic ribs 84i, 86i arranged one above the other from one another.

The backrest 34i has a lower backrest element 52i. The lower backrest element 52i is embodied rigidly. The lower backrest element 52i is preferably embodied immovably. The lower backrest element 52i forms a lower region of the backrest 34i. The lower backrest element 52i forms the backrest contact surface in the lower region of the backrest 34i. The lower backrest element 52i is fastened fixedly to the seat structure elements 26i, 28i. The lower backrest element 52i extends substantially between a height of the transverse beams 22i, 24i of the mounting unit 12i and a lower end of the pivotable backrest element 36i. The lower backrest element 52i is formed by a shell element. The lower backrest element 52i is formed by a shell composed of a fiber-reinforced plastic. For example, it is conceivable for the lower backrest element 52i to be formed by a GRP or a CFP shell. In principle, it would also be conceivable for the lower backrest element 52i to be formed from a different material, for example from a metal sheet, from a film, or from a multilayer structure with a honeycomb structure. The lower backrest element 52i has an upper region 152i. The upper region 152i forms approximately an upper quarter of the lower backrest element 52i. The uppermost 5-10 cm of the lower backrest element 52 i form the upper region 152 i. The backrest element 52i has a lip 104i at its upper end. The lip 104i forms an upper end region of the lower backrest element 52i. The lip 104i is formed in the upper region 152i of the lower backrest element 52i. The lip 104i forms an upper end of the upper region 152i of the lower backrest element 52i. The lip 104i is formed in one piece with the remainder of the lower backrest element 52i. The lip 104i is arranged centrally on the upper end of the lower backrest element 52i in the transverse direction.

The lower backrest element 52i is embodied as flexible in its upper region 152i. The lower backrest element 52i is embodied as more flexible in its upper region 152i than in its main region 102i arranged therebelow. The lower backrest element 52i is embodied as elastically deflectable in its upper region 152i. In order to form the flexibility in the upper region 152i, the lower backrest element 52i has a recess pattern 154i in the upper region 152i. The recess pattern 154i is formed by at least one of recesses 156i introduced into the lower backrest element 52i. The recess pattern 154i is arranged merely in the upper region 152i. In principle, it would also be conceivable for the recess pattern 154i to be arranged merely in the region of the lip 104i. In the present exemplary embodiment, the recess pattern 154i is formed by a plurality of recesses 156i arranged at a distance from one another and embodied as slots. The recesses 156i embodied as slots extend from an upper edge of the lower backrest element 52i to below the lip 104i. In principle, it would also be conceivable for the recesses 156i to extend merely to a lower edge of the lip 104i. The recesses 156i embodied as slots have a width of 10 mm. In principle, it would also be conceivable for the recesses 156 i embodied as slots to have a width which lies in a range from 5 mm to 30 mm. By way of example, four recesses 156i embodied as slots are shown in the exemplary embodiment. In principle, it would also be conceivable for the recess pattern 154i to have a different number of recesses 156i embodied as slots. In principle, it would also be conceivable for the recesses 156i embodied as slots to be embodied narrower.

In principle, however, it would also be conceivable for the lower backrest element 52i to be formed from a combination of different materials. For example, it would be conceivable for the upper region 152i or the lip 104i of the lower backrest element 52i to be formed from a different material than the main region 102i. For example, it would be conceivable for the main region 102i to be formed from a flexurally rigid fiber composite material or a metal sheet and for the upper region to be formed from a flexible plastic or fiber composite material which is fixedly connected to the main region 102i. If the lower backrest element 52i is formed from a fiber composite material, the upper flexible region 152i is preferably formed from a smaller number of layers of fiber composite layers than the main region 102i. As a result, the upper region 152i can be embodied particularly simply more flexibly than the main region 102i and the lower backrest element 52i can advantageously be embodied in one piece.

The aircraft seat device has a restoring module 56i. The restoring module 56i is configured to restore the backrest 34i from the comfort position into an upright sitting position. The restoring module 56i is configured to restore the backrest 34i from its pivoted sitting position into the upright sitting position. The restoring module 56i is configured to restore the pivotable backrest element 36i. The restoring module 56i is configured to restore the backrest 34i, in particular to restore the pivotable backrest element 36i, in order to provide a restoring force. The restoring module 56i is arranged at least substantially in a region above the bearing points 38i, 40i of the seat structure elements 26i, 28i. The restoring module 56i is arranged at least substantially above, that is to say on a side facing away from the mounting plane, the armrest height X. The restoring module 56i is arranged at least to a large extent above the knee region 50i of the backrest 34i.

The restoring module 56i has a locking unit 88i. The locking unit 88i is configured to lock or unlock the restoring module 56i. The locking unit 88i is configured to lock the backrest 34i, that is to say the pivotable backrest element 36i, at least in the upright sitting position and in the comfort position. The locking unit 88i is configured to lock the backrest 34i in its upright sitting position. The locking unit 88i is configured to lock the pivotable backrest element 36i in the upright sitting position. The locking unit 88i can lock the pivotable backrest element 36i in the comfort position and in the upright sitting position. The locking unit 88i has a locked state and an unlocked state. In the locked state of the locking unit 88i, the backrest 34i, in particular the pivotable backrest element 36i, is locked in the current position, that is to say either the upright sitting position or the comfort position. In the locked position of the locking unit 88i, the pivotable backrest element 36i is fixed in a form-fitting manner in a position, that is to say the upright sitting position or the comfort position. In the locked position of the locking unit 88i, the pivotable backrest element 36i is fixed in a positionally fixed manner relative to the mounting unit 12i. Preferably, the locking unit 88i is configured only for locking the backrest 34i, that is to say the pivotable backrest element 36i, in the upright sitting position and in the comfort position. The locking unit 88i is preferably arranged for the most part above the bearing points 38i, 40i. The locking unit 88i is arranged between the seat structure elements 26i, 28i and the pivotable backrest element 36i.

The locking unit 88i has a first locking module 172i. The first locking module 172i of the locking unit 88i is arranged on a left-hand side of the pivotable backrest element 36i. The first locking module 172i is arranged between the first, left-hand seat structure element 26i and the backrest frame 60i. The first locking module 172i is arranged functionally between the left-hand bearing bolt 46i and the left-hand lateral frame element of the backrest frame 38i. The locking unit 88i has a second locking module 174i. The second locking module 174i of the locking unit 88i is arranged on a right-hand side of the pivotable backrest element 36i. The second locking module 174i is arranged between the second, right-hand seat structure element 28i and the backrest frame 38i. The second locking module 174i is arranged functionally between the right-hand bearing bolt 48i and the right-hand lateral frame element of the backrest frame 38i. The two locking modules 172i, 174i are configured together for locking the backrest 34i, in particular the pivotable backrest element 36i. The two locking modules 172i, 174i of the locking device 70i are embodied in a substantially identical manner. The locking modules 172i, 174i are embodied in a substantially mirror-inverted manner with respect to one another. Preferably, merely actuation connections or elements for transmitting an actuation force are different in the case of the locking modules 172i, 174i. The locking modules 172i, 174i have a substantially identical structure which is mirror-inverted with respect to one another.

The locking module 172i has a first locking unit 176i. The first locking unit 176i is configured for the purpose of being fastened to the pivotable backrest element 36i. The first locking unit 176i forms a part of the locking module 172i which faces the pivotable backrest element 36i. The locking module 172i has a second locking unit 178i. The second locking unit 178i is configured for the purpose of being captively mounted on the bearing bolt 46i. The second locking unit 178i forms a part of the locking module 172i which faces the mounting unit 12i. The first locking unit 176i and the second locking unit 178i of the locking module 172i are supported movably with respect to one another. The first locking unit 176i and the second locking unit 178i are supported movably with respect to one another about the axis of rotation 44i by the connection to the pivotable backrest element 36i or to the bearing bolt 46i via the support of the pivotable backrest element 36i. The first locking unit 176i has a locking element which is adjustable in a spring-loaded manner between a locked position and a release position. The locking element is configured for form-fitting connection to the second locking unit 178i.

The restoring module 56i has a first spring element 58i for providing a restoring force. The restoring module 56i has a second spring element 158i for providing a restoring force. In contrast to the preceding exemplary embodiments, the restoring module has two spring elements 58i, 158i. The spring elements 58i, 158i are each arranged on one side of the backrest frame 60i. The spring elements 58i, 158i are each attached to a lateral frame element of the backrest frame 60i. In the exemplary embodiment shown, the spring elements 58i, 158i are each attached to an outer side of a lateral frame element of the backrest frame 60i. The spring elements 58i, 158i are embodied as flexural springs. The spring elements 58i, 158i are preferably embodied as metallic flexural springs. The spring elements 58i, 158i are configured to provide a spring force.

The spring force of the spring elements 58i, 158i forms the restoring force of the restoring module 56i. The spring elements 58i, 158i are arranged functionally between the pivotable backrest element 36i and the mounting unit 12i. The spring elements 58i, 158i are configured to be braced on the mounting unit 12i with a first side. The spring elements 58i, 158i are configured to be braced on the pivotable backrest element 36i with a second side. The spring elements 58i, 158i are each arranged functionally between one of the seat structure elements 26i, 28i and a lateral frame element of the backrest frame 60i. The spring elements 58i, 158i are each embodied identically and attached equivalently to the backrest frame 60i. Therefore, only the one spring element 58i and the attachment thereof will be described below, wherein the description can be used to explain the second spring element 158i. The spring element 58i is embodied as a spiral spring. The spring element 58i has a spiral-shaped central region 160i and two spring legs 162i, 164i protruding from the central region 160i. The restoring module 65i has a bearing element 166i via which the spring element 58i is attached to the backrest frame 60i. The bearing element 166i is embodied as a bearing cylinder. The bearing element 166i has a cylinder lateral surface on which the spring element 58i rests with its spiral-shaped central region 160i. The spring element 58i surrounds the bearing element 166i with its spiral-shaped central region 160i. The bearing element 166i is fixedly attached to the outer side of the lateral frame element of the backrest frame 60i. Preferably, the bearing element 166i is screwed in a positionally fixed manner to the outer side of the lateral frame element of the backrest frame 60i via a screw connection. The first spring leg 162i is configured for bracing on the bearing bolt 46i. The first spring leg 162i is configured for bracing on the first locking unit 176i. For bracing of the first spring leg 162i, the restoring module 56i has a first bracing element 168i. The first spring leg 162i is braced on the bracing element 168i which is formed by the first locking unit 176i. The bracing element 168i is preferably formed by a main body 180i of the first locking unit 176i. The second spring leg 164i is configured for bracing on the backrest element 36i. The second spring leg 164i is configured for bracing on the lateral frame element of the backrest frame 60i. The restoring module 56i has a second bracing element 170i for bracing of the second spring leg 164i. The second bracing element 170i is configured for bracing of the second spring leg 164i on the backrest frame 60i. The bracing element 170i is embodied as a bracing bolt which is fixedly attached to a side face of the lateral frame element of the backrest frame 60i. Preferably, the bracing element 170i is attached by means of a screw connection. For support, the spring leg 164i of the spring element 58i abuts against the bracing element 170i.

By means of the two separate spring elements 58i, 158i, which are each arranged on one side of the backrest frame 60i, a restoring force provided by the restoring module can advantageously act uniformly on both sides of the pivotable backrest element 36i. As a result, it is advantageously possible in particular to dispense with further stiffening of the backrest frame 60i between the two lateral frame elements in a middle region. As a result, the pivotable backrest element 36i can be embodied advantageously lightly.

In principle, it would also be conceivable for the spring elements 58i, 158i and/or the locking modules 172i, 174i of the locking unit 88i to be attached in each case to an inner side of the respective lateral frame element of the backrest frame 60i. As a result of the attachment of the spring elements 58i, 158i and/or the locking modules 172i, 174i of the locking unit 88i within the backrest frame 60i, the pivotable backrest element 36i could be embodied particularly advantageously.

The aircraft seat device has a lower covering module 182i. The lower covering module 182i is configured for at least partially covering a lower region of the backrest 34i toward a rear side. The lower covering module 182i is preferably configured for covering at least a partial region of the lower backrest element 52i. The lower covering module 182i covers the lower backrest element 52i to the rear in a partial region. The lower covering module 182i has a covering element 184i. The covering element 184i is arranged in an upper region of the lower backrest element 52i. The covering element 184i is arranged centrally on the lower backrest element 52i on the rear side thereof. The covering element 184i covers at least the lip 104i and the upper region 152i of the lower backrest element 52i. The covering element 184i is configured for covering the flexible upper region 152i of the lower backrest element 52i to the rear. The covering element 184i is connected to the lower backrest element 52i.

Preferably, the covering element is releasably connected to the lower backrest element 52i via form-fitting elements, preferably in particular via screw connections. The covering element 184i can preferably form a literature bag 188i or other additional units.

The covering element 184i does not cover a lower region of the lower backrest element 52i. The lower backrest element 52i forms in its lower region a visible surface 186i which is not covered to the rear. The visible surface of the lower backrest element 52i is not covered by any covering element 184i of the covering module 182i. The visible surface 186i of the lower backrest element 52i can be coated with a coating or a film. In principle, it is also conceivable for the backrest element 52i not to have a coating in its visible surface 186i. The lower backrest element 52i forms with its visible surface 186i a kick panel of the backrest 34i.

The aircraft seat device has an upper covering module 190i. The upper covering module 190i is configured for covering the upper region of the backrest 34i, in particular the pivotable backrest element 36i, to the rear. The upper covering module 190i has a covering element 192i. The covering element 192i preferably extends over an entire rear side of the upper, pivotable backrest element 36i. The upper covering module 190i preferably covers the laterally arranged locking modules 172i, 174i of the locking unit 88i. Preferably, it is conceivable for the upper covering module 190i to have separately demountable covering elements in the regions of the locking modules 172i, 174i, which covering elements can be separated individually from the backrest element 36i in order to reach the locking modules 172i, 174i in a simple manner. The covering element 192i forms a literature bag 194i in its upper region. The literature bag 194i is arranged in a head region of the backrest 34i. The aircraft seat device additionally has a pivotable table 196i. The pivotable table can be folded onto the covering element 192i of the upper covering module 190i.

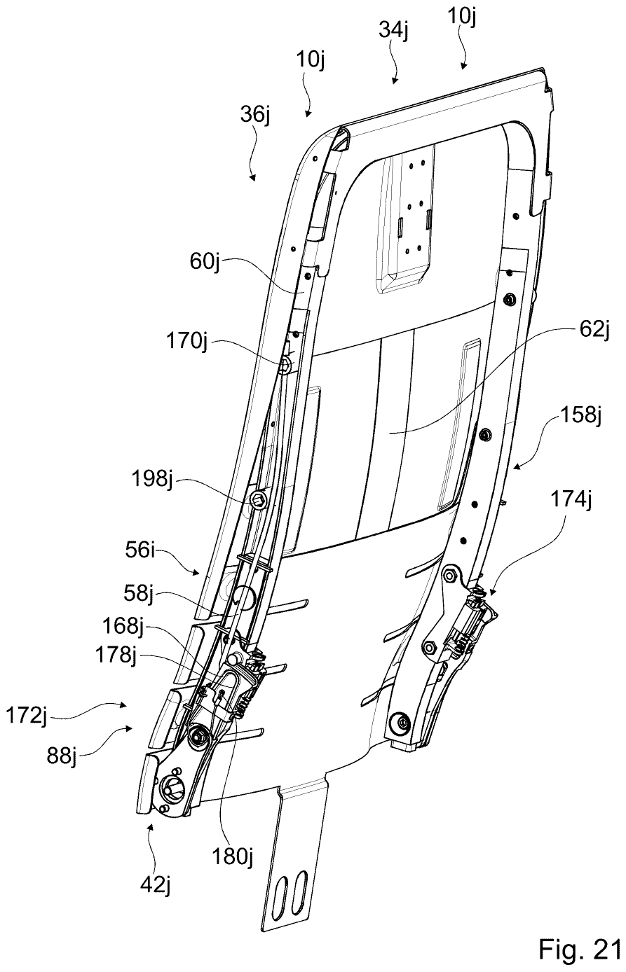

FIG. 21 shows a tenth exemplary embodiment of an aircraft seat device according to the invention. The aircraft seat device is embodied substantially identically to the aircraft seat device of the ninth exemplary embodiment. The aircraft seat device comprises a backrest 34j. The backrest 34j is configured such that a person sitting on the aircraft seat 10j, whose part is the aircraft seat device, can rest his/her back on the backrest 34j. The backrest 34j has a pivotable backrest element 36j. The pivotable backrest element 36j is pivotably supported on a mounting unit 12j. The aircraft seat device has a bearing device 42j. The bearing device 42j is configured to support the backrest 34j pivotably between the upright sitting position and the comfort position. The pivotable backrest element 36j has a backrest frame 60j. The aircraft seat device has a restoring module 56j. The restoring module 56j is configured to restore the backrest 34j from the comfort position into an upright sitting position. The restoring module 56j has a locking unit 88j. The locking unit 88j is configured to lock or unlock the restoring module 56j. The locking unit 88j is configured to lock the backrest 34j, that is to say the pivotable backrest element 36j, at least in the upright sitting position and in the comfort position.

The restoring module 56j has a first spring element 58j and a second spring element 158j for providing a restoring force. In contrast to the preceding exemplary embodiment, the spring elements 58j, 158j are embodied as rod spring elements. The rod spring elements 58j, 158j are in each case arranged between a bracing element 170j attached to the backrest frame 60j and a bracing element 168j attached to a locking unit 178j. The spring element 58j embodied as a rod spring element is supported in each case by an end region with an identical first side on the respective bracing element 168j, 170j. The restoring module 56j has a deflection element 198j on which the spring element 58j embodied as a rod spring element can be supported by an opposite second side. The deflection element 198j is arranged between the two bracing elements 168j, 180j. The deflection element 198j is arranged substantially centrally between the two bracing elements 168j, 170j. The deflection element 198j is embodied as a bracing bolt which is attached to the backrest frame. The deflection element 198j is screwed to an outer side of the lateral frame element of the backrest frame 60j.

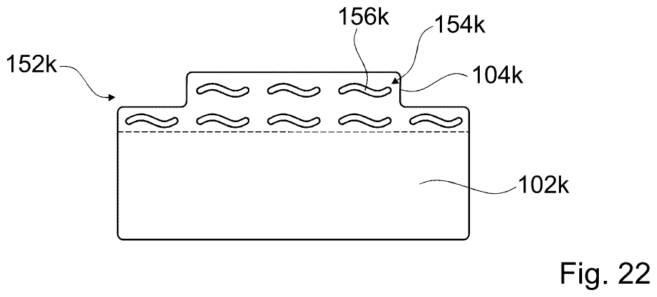

FIG. 22 shows an alternative implementation of a lower backrest element 52k in a further exemplary embodiment. The basic embodiment of the aircraft seat device is substantially identical to the implementation of the ninth exemplary embodiment. The lower backrest element 52k is embodied as flexible in its upper region 152k. The lower backrest element 52k is embodied as more flexible in its upper region 152k than in its main region 102k arranged therebelow. The lower backrest element 52k is embodied as elastically deflectable in its upper region 152k. In order to form the flexibility in the upper region 152k, the lower backrest element 52k has a recess pattern 154k in the upper region 152k. The recess pattern 154k is formed by at least one recess 156k introduced into the lower backrest element 52k. The recess pattern 154k is arranged merely in the upper region 152k. In the present exemplary embodiment, the recesses 156k are embodied as undulating recesses 156k. The undulating recesses 156k run in a transverse direction. A plurality of undulating recesses 156k are preferably arranged in a row at a distance from one another in a transverse direction. In principle, it would also be conceivable for the recesses 156k to have a different shape or to form different shapes.

1. An aircraft seat device having a mounting unit which is configured for mounting on a cabin floor and has at least one transverse beam, having two seat structure elements which are each arranged on one side of a seat region and each have a bearing point having a backrest which is attached via the bearing points of the seat structure elements, and having a bearing device which is configured for supporting the backrest pivotably between an upright sitting position and a comfort position, wherein the backrest comprises a pivotable backrest element, the aircraft seat device further comprising at least one restoring module which is configured at least for providing a restoring force for restoring the backrest from the comfort position into the upright sitting position and for this purpose is arranged at least substantially in a region above the bearing points of the seat structure elements.

2. The aircraft seat device according to claim 1, wherein the seat structure elements extend in their rear region upwards, away from the mounting unit, up to at least substantially an armrest height, wherein the seat structure elements each have at their rear, upper end the bearing point for supporting the pivotable backrest element.

3. The aircraft seat device according to claim 1, wherein the restoring module has at least one spring element which is configured for providing the restoring force.

4. The aircraft seat device according to claim 1, wherein the backrest has a lower backrest element which forms a lower region of the backrest and is fastened to the seat structure elements.

5. The aircraft seat device according to claim 4, wherein the lower backrest element extends from a height of the at least one transverse beam up to a height of 450 mm-700 mm measured from a mounting plane.

6. The aircraft seat device according to claim 4, wherein the spring element is embodied as a leaf spring element and is configured for being attached to the lower backrest element or to the mounting unit.

7. The aircraft seat device according to claim 3, wherein the backrest has in a region above the bearing points a transverse beam to which the spring element embodied as a leaf spring element is attached for transmitting a restoring force to the pivotable backrest element.

8. The aircraft seat device according to claim 4, wherein the lower backrest element has at its upper end an upper lip which extends into a region above the bearing points, for supporting the backrest.

9. The aircraft seat device according to claim 1, wherein the pivotable backrest element has a backrest frame and a fabric which is clamped onto the backrest frame, or a shell element which is connected to the backrest frame.

10. The aircraft seat device according to claim 1, wherein the restoring module has a spring element which is embodied as a gas pressure spring and is arranged in a region above the bearing points.

11. The aircraft seat device according to claim 1, wherein the restoring module has at least one lever gear which is configured for transmitting a restoring force to the pivotable backrest element.

12. The aircraft seat device according to claim 1, wherein the restoring module has a torsion tube which transmits a restoring force from one side of the pivotable backrest element to an opposite side.

13. The aircraft seat device according to claim 1, wherein the bearing points for supporting the pivotable backrest element define an axis of rotation which is arranged above a knee region of the backrest.

14. The aircraft seat device according to claim 6, wherein the spring element embodied as a leaf spring element for providing a restoring force is formed in one piece with the lower backrest element.

15. The aircraft seat device according to claim 3, wherein the spring element for generating the restoring force is at least partially formed in one piece with the pivotable backrest element.

16. The aircraft seat device according to claim 2, wherein the restoring module has at least one spring element which is configured for providing the restoring force.
